(19) United States
(12) Patent Application Publication
(10) Pub. No.: US 2026/0231192 A1
(43) Pub. Date: Aug. 6, 2026

(54) OPERATIONS FOR PERSISTENT RESOURCE-POOL-BASED LISTEN-BEFORE-TALK FAILURES

(71) Applicant: QUALCOMM Incorporated, San Diego, CA (US)

(72) Inventors: Stelios STEFANATOS, San Diego, CA (US); Qing LI, Princeton Junction, NJ (US); Giovanni CHISCI, San Diego, CA (US); Chih-Hao LIU, San Diego, CA (US); Gabi SARKIS, San Diego, CA (US)

(21) Appl. No.: 19/146,356

(22) PCT Filed: Nov. 29, 2023
(86) PCT No.: PCT/US2023/081592

§ 371 Date: Jul. 8, 2025

(30) Foreign Application Priority Data
Feb. 16, 2023 (GR) 20230100128

(51) Int. Cl. H04W 72/40; H04W 72/0453; H04W 74/0808

(52) U.S. Cl. CPC H04W 72/40; H04W 72/0453; H04W 74/0808

(57) ABSTRACT

Various aspects of the present disclosure generally relate to wireless communication. Various aspects relate generally to operations for persistent resource-pool-based listen-before-talk (LBT) failures. Some aspects more specifically relate to defining the operations to be performed by a user equipment (UE) in response to a resource-pool-level persistent LBT failure report to mitigate future LBT failures. In some aspects, an operation in response to a resource-pool-level persistent LBT failure report for a given resource pool may include refraining from attempting sidelink transmissions via the given resource pool. For example, the UE may direct traffic, that would have otherwise been attempted to be transmitted via the given resource pool, to one or more alternative resource pools.

### CROSS-REFERENCE TO RELATED APPLICATION

This Patent Application claims priority to Greece Patent Application No. 20230100128, filed on Feb. 16, 2023, entitled “OPERATIONS FOR PERSISTENT RESOURCE-POOL-BASED LISTEN-BEFORE-TALK FAILURES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for operations for persistent resource-pool-based listen-before-talk (LBT) failures.

### BACKGROUND

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Selection of sidelink resources, via a medium access control (MAC) layer and a physical (PHY) layer for a user equipment (UE) operating in a sidelink Mode 2, can occur using resources included in a resource pool. In a configured sidelink bandwidth part (BWP) in an unlicensed channel, each of one or more resource pools can be divided into one or more resource block (RB) sets. Each RB set can be divided into one or more subchannels and each subchannel can be divided into one or more RBs. To use subchannels within an RB set, the UE may perform a listen-before-talk (LBT) procedure. In some cases, a UE may perform an LBT operation by sensing resources associated with one or more RB sets. If the LBT procedure is successful over the one or more RB sets, then the UE may transmit a sidelink communication using the subchannels (for example, included in an RB set of the one or more RB sets associated with the LBT procedure). If the LBT procedure is not successful, then the UE may not transmit using the subchannels. This may be referred to as an LBT failure.

In some examples, a UE may experience a “persistent LBT failure,” which may refer to a scenario where the UE repeatedly fails to access a shared channel due to multiple LBT failures. For example, a persistent LBT failure may be triggered or detected based on, or otherwise associated with, a rate of LBT failures experienced by the UE. In some examples, a UE may detect a persistent LBT failure based on, in response to, or otherwise associated with a quantity of LBT failures, over a given time interval, satisfying a persistent LBT failure threshold. The UE may generate a persistent LBT failure report based on, in response to, or otherwise associated with detecting a persistent LBT failure.

A persistent LBT failure report may be associated with an RB-set-level granularity or a resource-pool-level granularity. In some examples, the persistent LBT failure report may indicate that a quantity of LBT failures associated with at least one RB set of a configured resource pool satisfies the persistent LBT failure threshold. For example, if the persistent LBT failure report is associated with the RB-set-level granularity, then the persistent LBT failure report may indicate a likelihood of LBT success associated with each RB set. In other examples, if the persistent LBT failure report is associated with the resource-pool-level granularity, then the persistent LBT failure report may indicate a likelihood of LBT success associated with a given resource pool. For example, the persistent LBT failure report may indicate that a quantity of LBT failures, associated with any RB set included in the resource pool, over a given time interval (for example, a sliding time window) satisfies the persistent LBT failure threshold. In other words, an LBT failure associated with any one of multiple RB sets included in a resource pool will contribute to an LBT failure count for the resource pool. If the LBT failure count, over the given time interval (for example, a sliding time window) satisfies the persistent LBT failure threshold, then the UE may generate and/or transmit a persistent LBT failure report for the resource pool.

However, operations to be performed by a UE in response to a resource-pool-level persistent LBT failure report are not defined. For example, if a resource-pool-level persistent LBT failure report is generated, then the UE may be unable to identify which RB set(s) and/or subchannel(s) within the resource pool are associated with LBT failures (for example, because the resource-pool-level persistent LBT failure report may be generated for LBT failures associated with any RB set included in the resource pool). Therefore, the UE may continue to use the resource pool to select resources for future sidelink transmissions without knowledge of which RB set(s) and/or subchannel(s) are unavailable. For example, the UE may continue to attempt to access an unlicensed channel or frequency band using RB set(s) and/or subchannel(s), included in the resource pool, that are unavailable (for example, because the UE is unable to identify which RB set(s) and/or subchannel(s) are unavailable). This may result in the UE being unable to access the unlicensed channel or frequency band for sidelink transmissions. As a result, the UE may experience increased latency, data loss, and/or reduced performance, among other examples, associated with attempted sidelink transmissions via the unlicensed channel or frequency band.

Additionally, the UE may attempt to switch to another resource pool in response to generating the resource-pool-level persistent LBT failure report. However, the UE may switch to a resource pool that is also associated with a congested channel (for example, thereby resulting in LBT failures similar to the resource pool associated with the persistent LBT failure report) and/or to a resource pool that is not being monitored by an intended recipient of a sidelink communication to be transmitted by the UE.

### SUMMARY

Some aspects described herein relate to a user equipment (UE) for wireless communication. The UE may include a processing system that includes one or more processors and one or more memories coupled with the one or more processors. The processing system may be configured to cause the UE to receive configuration information indicating multiple resource pools associated with sidelink communications for a shared frequency band. The processing system may be configured to cause the UE to transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent listen-before-talk (LBT) failure, the persistent LBT failure being associated with one or more LBT failures via resources associated with the first resource pool.

Some aspects described herein relate to a network node for wireless communication. The network node may include a processing system that includes one or more processors and one or more memories coupled with the one or more processors. The processing system may be configured to cause the network node to transmit configuration information, associated with a UE, indicating multiple resource pools associated with sidelink communications for a shared frequency band, the configuration information associated with one or more alternative resource pools for resource-pool-based persistent LBT failures associated with the multiple resource pools.

Some aspects described herein relate to a method of wireless communication by a UE. The method may include receiving configuration information indicating multiple resource pools associated with sidelink communications for a shared frequency band. The method may include transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool.

Some aspects described herein relate to a method of wireless communication by a network node. The method may include transmitting configuration information, associated with a UE, indicating multiple resource pools associated with sidelink communications for a shared frequency band, the configuration information associated with one or more alternative resource pools for resource-pool-based persistent LBT failures associated with the multiple resource pools.

Some aspects described herein relate to a non-transitory computer-readable medium that stores a set of instructions for wireless communication by a UE. The set of instructions, when executed by one or more processors of the UE, may cause the UE to receive configuration information indicating multiple resource pools associated with sidelink communications for a shared frequency band. The set of instructions, when executed by one or more processors of the UE, may cause the UE to transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool.

Some aspects described herein relate to a non-transitory computer-readable medium that stores a set of instructions for wireless communication by a network node. The set of instructions, when executed by one or more processors of the network node, may cause the network node to transmit configuration information, associated with a UE, indicating multiple resource pools associated with sidelink communications for a shared frequency band, the configuration information associated with one or more alternative resource pools for resource-pool-based persistent LBT failures associated with the multiple resource pools.

Some aspects described herein relate to an apparatus for wireless communication. The apparatus may include means for receiving configuration information indicating multiple resource pools associated with sidelink communications for a shared frequency band. The apparatus may include means for transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool.

Some aspects described herein relate to an apparatus for wireless communication. The apparatus may include means for transmitting configuration information, associated with a UE, indicating multiple resource pools associated with sidelink communications for a shared frequency band, the configuration information associated with one or more alternative resource pools for resource-pool-based persistent LBT failures associated with the multiple resource pools.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of sidelink communications in accordance with the present disclosure.

FIG. 5 is a diagram illustrating an example of sidelink communications and access link communications in accordance with the present disclosure.

FIG. 6 is a diagram of an example associated with operations for persistent resource-pool-based listen-before-talk (LBT) failures in accordance with the present disclosure.

FIG. 7 is a diagram of an example associated with operations for persistent resource-pool-based LBT failures in accordance with the present disclosure.

FIG. 8 is a flowchart illustrating an example process performed, for example, by a UE that supports operations for persistent resource-pool-based LBT failures in accordance with the present disclosure.

FIG. 9 is a flowchart illustrating an example process performed, for example, by a network node that supports operations for persistent resource-pool-based LBT failures in accordance with the present disclosure.

FIG. 10 is a diagram of an example apparatus for wireless communication that supports operations for persistent resource-pool-based LBT failures in accordance with the present disclosure.

FIG. 11 is a diagram of an example apparatus for wireless communication that supports operations for persistent resource-pool-based LBT failures in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to operations for persistent resource-pool-based listen-before-talk (LBT) failures. Some aspects more specifically relate to defining the operations to be performed by a user equipment (UE) in response to a resource-pool-level persistent LBT failure report to mitigate future LBT failures. In some aspects, an operation in response to a resource-pool-level persistent LBT failure report for a given resource pool may include refraining from attempting sidelink transmissions via the given resource pool. For example, the UE may direct traffic, that would have otherwise been attempted to be transmitted via the given resource pool, to one or more alternative resource pools. In some aspects, one or more parameters may be defined for a selection of an alternative resource pool in response to a resource-pool-level persistent LBT failure report. For example, the UE may select the one or more alternative resource pools based on, or otherwise associated with, the one or more parameters. The one or more parameters may include a size of a frequency domain overlap between an alternative resource pool and the given resource pool (for example, that is associated with the persistent LBT failure).

Additionally or alternatively, the one or more parameters may include a comparison of one or more configuration parameters for an alternative resource pool and the given resource pool. The one or more configuration parameters may include radio resource parameters (for example, a quantity of time domain resources and/or a quantity of frequency domain resources) and/or feature parameters (for example, a physical sidelink feedback channel (PSFCH) configuration), among other examples. In some aspects, one or more parameters may be defined for a UE to determine when a use of a resource pool, that is associated with a resource-pool-level persistent LBT failure report, may be resumed. For example, the one or more parameters may include a timer (for example, an amount of time from detecting the persistent LBT failure). Additionally or alternatively, the one or more parameters may be associated with an activity level associated with the resource pool.

Particular aspects of the subject matter described in this disclosure can be implemented to realize one or more of the following potential advantages. In some examples, the described techniques can be used to enable a UE to handle a resource-pool-level persistent LBT failure when operating in Mode 2 (for example, without assistance of a network node). For example, stopping a use of a resource pool associated with a persistent LBT failure and directing sidelink traffic to one or more alternative resource pools reduces latency associated with the sidelink traffic, reduces a likelihood that the UE experiences an LBT failure when attempting to transmit the sidelink traffic, and/or reduces a likelihood of losing or dropping the sidelink traffic (for example, due to being unable to access an unlicensed or shared channel), among other examples. Additionally, defining one or more parameters for selecting one or more alternative resource pools reduces a likelihood that an alternative resource pool is associated with similar LBT failures and/or improves a likelihood that an alternative resource pool supports similar configuration parameters as the resource pool that is associated with the persistent LBT failure. Further, defining one or more parameters for resuming a use of a resource pool that is associated with the persistent LBT failure enables the UE to use the resource pool (for example, thereby improving resource utilization) while also reducing a likelihood that the UE will continue to experience LBT failures when resuming the use of the resource pool.

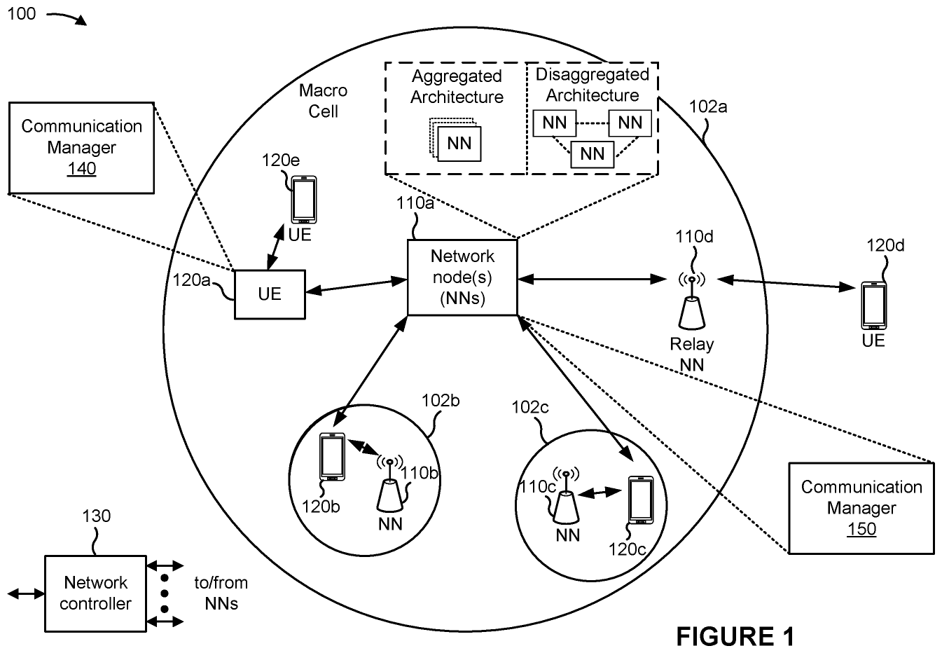

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FRI is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information indicating multiple resource pools associated with sidelink communications for a shared frequency band; and transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool. Additionally or alternatively, the communication manager 140 may perform one or more other operations described herein.

In some aspects, the network node 110 may include a communication manager 150. As described in more detail elsewhere herein, the communication manager 150 may transmit configuration information, associated with a UE, indicating multiple resource pools associated with sidelink communications for a shared frequency band, the configuration information associated with one or more alternative resource pools for resource-pool-based persistent LBT failures associated with the multiple resource pools. Additionally or alternatively, the communication manager 150 may perform one or more other operations described herein.

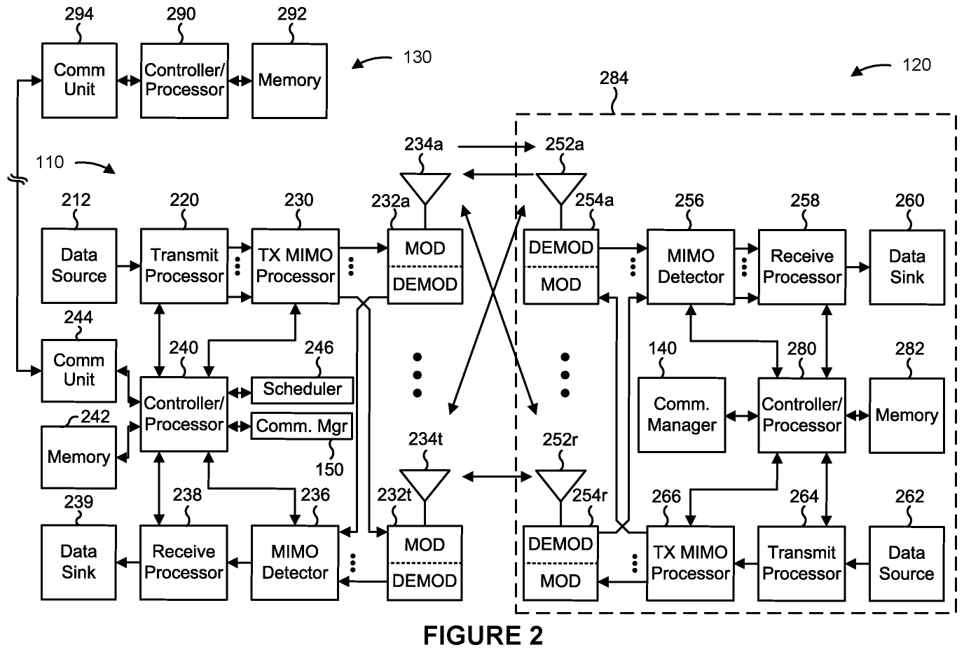

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280.

The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

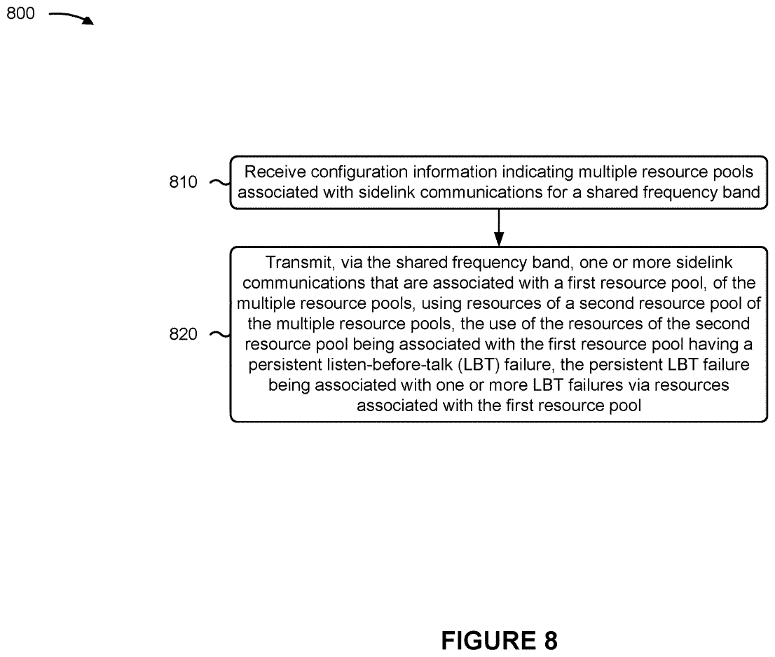

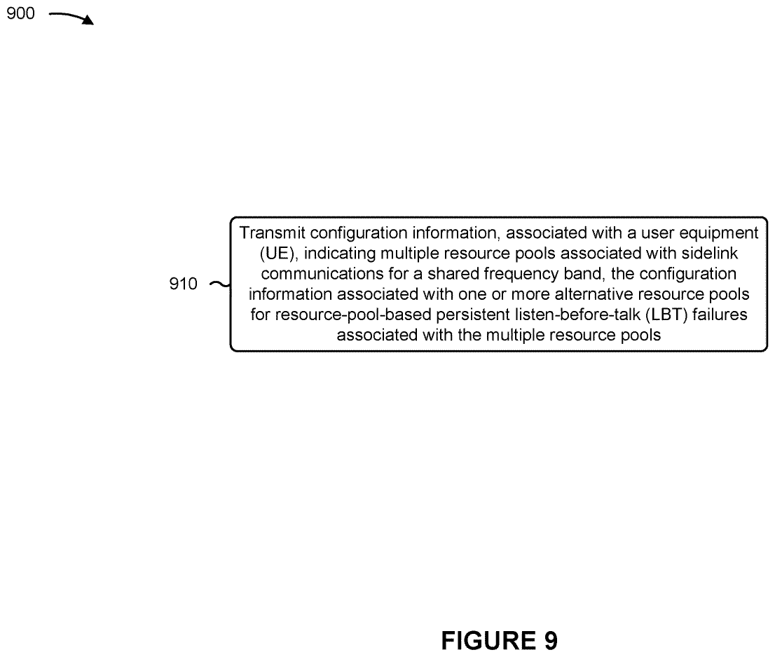

The controller/processor 240 of the network node 110, the controller/processor 280 of the UE 120, or any other component(s) of FIG. 2 may perform one or more techniques associated with operations for persistent resource-pool-based LBT failures, as described in more detail elsewhere herein. For example, the controller/processor 240 of the network node 110, the controller/processor 280 of the UE 120, or any other component(s) of FIG. 2 may perform or direct operations of, for example, process 800 of FIG. 8, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, or other processes as described herein. In some examples, executing instructions may include running the instructions, converting the instructions, compiling the instructions, or interpreting the instructions, among other examples.

In some aspects, the UE 120 includes means for receiving configuration information indicating multiple resource pools associated with sidelink communications for a shared frequency band; and/or means for transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information, associated with a UE, indicating multiple resource pools associated with sidelink communications for a shared frequency band, the configuration information associated with one or more alternative resource pools for resource-pool-based persistent LBT failures associated with the multiple resource pools. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (for example, triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

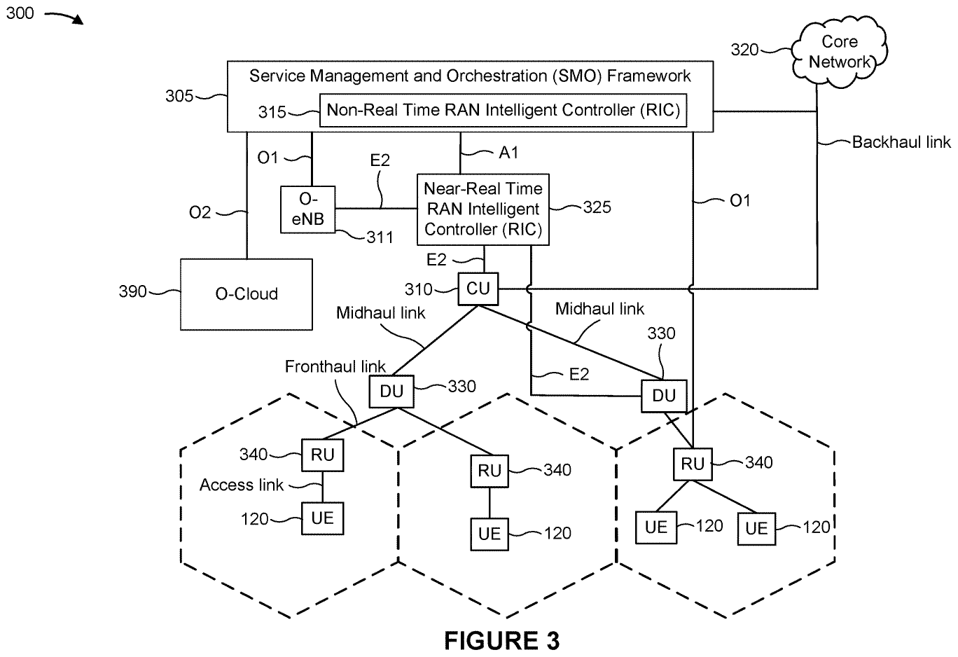

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

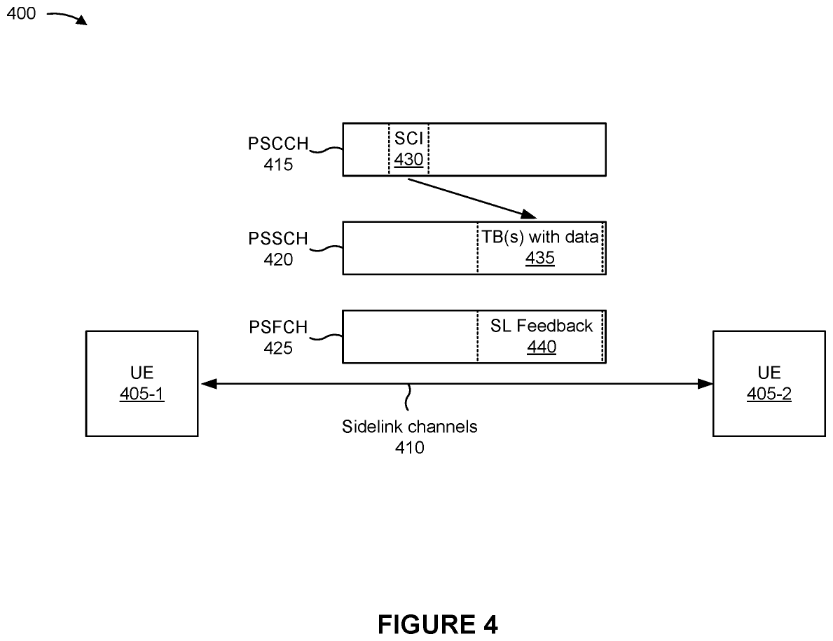

FIG. 4 is a diagram illustrating an example of sidelink communications 400 in accordance with the present disclosure. As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (for example, which may include V2V communications, V2I communications, and/or V2P communications) and/or mesh networking. In some aspects, the UEs 405 (for example, UE 405-1 and/or UE 405-2) may correspond to one or more other UEs described elsewhere herein, such as UE 120. In some aspects, the one or more sidelink channels 410 may use a PC5 interface and/or may operate in a high frequency band (for example, the 5.9 GHz band). Additionally or alternatively, the UEs 405 may synchronize timing of transmission time intervals (TTIs) (for example, frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (for example, time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (for example, acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (for example, time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (for example, included in SCI 430) may be transmitted in sub-channels using specific resource blocks (RBs) across time. In some aspects, data transmissions (for example, on the PSSCH 420) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 405 may operate using a sidelink transmission mode (for example, Mode 1) where resource selection and/or scheduling is performed by a network node 110 (for example, a base station, a CU, or a DU). For example, the UE 405 may receive a grant (for example, in downlink control information (DCI) or in a radio resource control (RRC) message, such as for configured grants) from the network node 110 (for example, directly or via one or more network nodes) for sidelink channel access and/or scheduling. In some aspects, a UE 405 may operate using a transmission mode (for example, Mode 2) where resource selection and/or scheduling is performed by the UE 405 (for example, rather than a network node 110). In some aspects, the UE 405 may perform resource selection and/or scheduling by sensing channel availability for transmissions. For example, the UE 405 may measure a received signal strength indicator (RSSI) parameter (for example, a sidelink-RSSI (S-RSSI) parameter) associated with various sidelink channels, may measure a reference signal received power (RSRP) parameter (for example, a PSSCH-RSRP parameter) associated with various sidelink channels, and/or may measure a reference signal received quality (RSRQ) parameter (for example, a PSSCH-RSRQ parameter) associated with various sidelink channels, and may select a channel for transmission of a sidelink communication based at least in part on the measurement(s).

Additionally or alternatively, the UE 405 may perform resource selection and/or scheduling using SCI 430 received in the PSCCH 415, which may indicate occupied resources and/or channel parameters. Additionally or alternatively, the UE 405 may perform resource selection and/or scheduling by determining a channel busy ratio (CBR) associated with various sidelink channels, which may be used for rate control (for example, by indicating a maximum quantity of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (for example, transmission parameters) to be used for an upcoming sidelink transmission, such as one or more resource blocks to be used for the upcoming sidelink transmission on the PSSCH 420 (for example, for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally or alternatively, the UE 405 may generate a sidelink grant for event-driven scheduling, such as for an on-demand sidelink message.

In some examples, a UE 405 may obtain a sidelink configuration indicating information and/or parameters associated with communicating via a sidelink channel. For example, the UE may receive the sidelink configuration from a network node (for example, via an RRC configuration). As another example, the UE 405 may receive the sidelink configuration from another UE (for example, via a sidelink RRC configuration). In some cases, the sidelink configuration (or a portion of the sidelink configuration) may be stored in a memory of the UE 405 prior to the UE 405 communicating with a network node or another UE (for example, the UE 405 may be pre-configured with the sidelink configuration or a portion of the sidelink configuration, such as in an original equipment manufacturer (OEM) configuration). Therefore, as used herein, a UE “obtaining” configuration information may refer to the UE receiving a signal that indicates the configuration information and/or the UE retrieving the configuration information from a memory of the UE.

Some sidelink configuration parameters or configuration fields described herein may be defined, or otherwise fixed, by a wireless communication standard, such as the 3GPP (for example, such as in 3GPP Technical Specification (T.S.) 38.331 Version 17.3.0). For example, the sidelink configuration may include a sidelink frequency configuration (SL-FreqConfig). The SL-FreqConfig may indicate dedicated configuration information on one particular carrier frequency for sidelink communication. For example, the SL-FreqConfig may include a field (for example, sl-AbsoluteFrequencyPointA) indicating a frequency reference point of a reference resource block (for example, common RB 0). The field (for example, sl-AbsoluteFrequencyPointA) may indicate a lowest subcarrier associated with the sidelink channel, which may be referred to as “Point A.” Additionally or alternatively, the SL-FreqConfig may indicate additional configuration information, such as a frequency location of a sidelink synchronization signal block (SSB) (for example, via an sl-AbsoluteFrequencySSB field), a list of sidelink bandwidth parts (BWPs) on which the sidelink communication configuration is to be added or reconfigured (for example, via an sl-BWP-ToAddModList field), a list of sidelink BWPs on which the sidelink communication configuration is to be released (for example, via an sl-BWP-ToReleaseList field), an identifier of the dedicated configuration information on the carrier frequency for sidelink communication (for example, via an sl-Freq-Id field), and/or one or more UE specific channel bandwidth and location configurations for different subcarrier spacings (SCSs) (for example, numerologies) that are defined in relation to Point A (for example, via an sl-SCS-SpecificCarrierList field), among other examples.

The sidelink configuration may include a sidelink BWP configuration (for example, an SL-BWP-Config). The SL-BWP-Config may indicate UE specific configuration information for sidelink communication on one particular sidelink BWP. For example, the SL-BWP-Config may include a generic BWP configuration (for example, in an sl-BWP-Generic field). The generic BWP configuration may indicate one or more generic parameters on the configured sidelink BWP, such as a bandwidth size of the BWP, a frequency location (for example, relative to the Point A) of the BWP, a numerology (for example, an SCS and/or cyclic prefix (CP), among other examples) of the BWP, time domain resource(s) associated with the BWP, a quantity of symbols used for sidelink in a slot without a sidelink SSB, a starting symbol used for sidelink in a slot without a sidelink SSB, and/or a subcarrier index within the carrier corresponding to the numerology of the corresponding sidelink BWP indicating a sidelink Tx/Rx Direct Current location for the carrier, among other examples.

The SL-BWP-Config may indicate resource pool configurations associated with one particular sidelink BWP (for example, via an sl-BWP-PoolConfig information element (IE) and/or an SL-ResourcePool IE). For example, the resource pool configurations may include one or more resource pool configurations associated with sidelink transmissions for the operating Mode 1, one or more resource pool configurations associated with sidelink transmissions for the operating Mode 2, and/or resource pool configurations associated with sidelink receptions, among other examples.

For example, an SL-ResourcePool IE may indicate configuration information for a given sidelink communication resource pool. The SL-ResourcePool IE may indicate one or more sidelink physical channel configurations for the resource pool (for example, an SL-PSCCH-Config, an SL-PSSCH-Config, and/or an SL-PSFCH-Config, among other examples). Additionally or alternatively, the SL-ResourcePool IE may indicate a quantity of subchannels associated with the resource pool (for example, via an sl-NumSubchannel field), a subchannel size (for example, in terms of a quantity of physical RBs (PRBs)) of the subchannels associated with the resource pool (for example, via an sl-SubchannelSize field), and/or a starting RB associated with the resource pool (for example, via an sl-StartRB-Subchannel field), among other examples. Additionally or alternatively, the SL-ResourcePool IE may indicate a time window size for CBR measurement associated with the resource pool (for example, via an sl-Time Window SizeCBR field), one or more MCSs associated with the resource pool (for example, via an SL-MinMaxMCS-Config IE and/or an sl-MCS-Table field), a sensing configuration associated with the resource pool (for example, via an sl-RS-ForSensing field, and/or an sl-SensingWindow field, among other examples), and/or a power control configuration associated with the resource pool (for example, via an SL-PowerControl IE), among other examples. The SL-ResourcePool IE may indicate additional configuration information, configuration parameters, and/or configuration fields, such as defined, or otherwise fixed, by 3GPP T.S. 38.331 Version 17.3.0.

As described above, a given BWP may be configured with multiple transmitting resource pools (for example, for transmitting sidelink communications) and/or multiple receiving resource pools (for example, for receiving sidelink communications). Physical sidelink channels may be configured per resource pool (for example, each resource pool may have separate physical sidelink channel configurations).

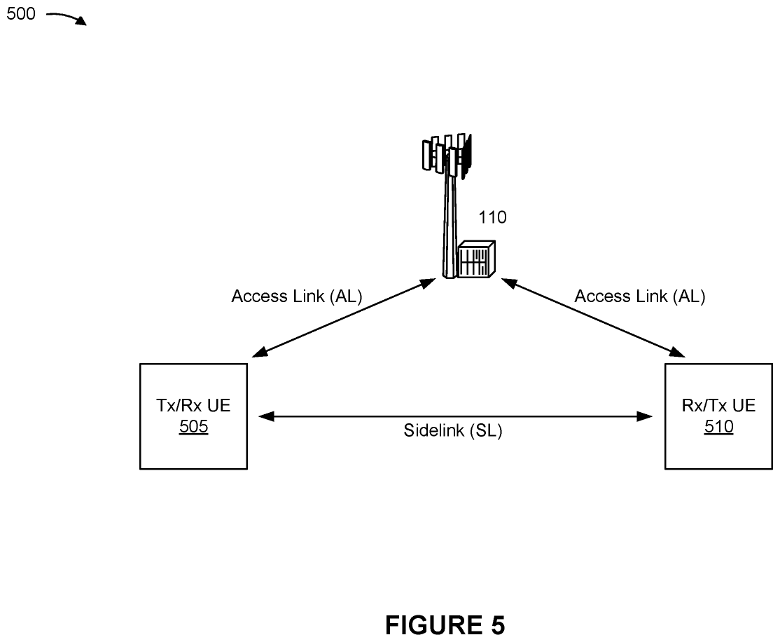

FIG. 5 is a diagram illustrating an example of sidelink communications and access link communications 500 in accordance with the present disclosure. As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (for example, directly or via one or more network nodes), such as via a first access link. Additionally or alternatively, in some sidelink modes, the network node 110 may communicate with the Rx/Tx UE 510 (for example, directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (for example, via a PC5 interface) may be referred to as a sidelink, and a direct link between a network node 110 and a UE 120 (for example, via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

Various techniques may be used to increase data rates associated with sidelink networks. For example, some wireless networks may support carrier aggregation for sidelink communication. As another example, some wireless networks may support sidelink communications via unlicensed frequency bands or shared frequency bands (for example, an unlicensed or shared frequency spectrum), thereby providing additional frequency domain resources that are available to be used for sidelink communications. “Shared” frequency band and “unlicensed” frequency band may be used interchangeably. A shared or unlicensed frequency band may be a frequency band that is associated with non-exclusive usage associated with various operators, devices, and/or RATs, among other examples. A shared or unlicensed frequency band may sometimes be referred to as a sidelink unlicensed (SL-U) frequency band.

In Mode 2, resource selection may include two steps. In a first step, the UE can identify candidate resources using sensing procedures and/or exclusion procedures. In a second step, the UE can perform a resource selection procedure in which the UE selects candidate resources from the identified candidate resources. Selection can be performed by higher protocol stack layers using random selection. For example, the PHY layer of the UE can report the set of candidate resources to the MAC layer of the UE. The MAC layer randomly chooses for transmission one or more resources of the set of candidate resources reported. In some cases, the UE can reserve resources for a HARQ transmission and/or retransmission, and the resources for multiple PSSCHs for the same transport block can be randomly selected by the MAC layer.

In an unlicensed frequency band, devices using different RATs may communicate using the same frequency band (for example, the same channel). For the two different types of devices (for example, using different RATs) to coexist while using a common carrier frequency, there is a need for a mechanism to efficiently utilize resource allocation by the two RATs without negatively impacting the operation of each RAT. For example, in an unlicensed frequency band, a transmitting device may contend against other devices for channel access before transmitting on a shared or unlicensed channel to reduce and/or prevent collisions on the shared or unlicensed channel. To contend for channel access, the transmitting device may perform a channel access procedure, such as a listen-before-talk (or listen-before-transmit) (LBT) procedure or another type of channel access procedure, for unlicensed frequency band channel access. The channel access procedure may be performed to determine whether the physical channel (for example, the radio resources of the channel) is free to use or is busy (for example, in use by another wireless communication device, such as a UE, an IoT device, or a wireless local area network (WLAN) device, among other examples).

The channel access procedure may include sensing or measuring the physical channel (for example, performing an RSRP measurement, detecting an energy level, or performing another type of measurement) during a channel access gap (which may also be referred to as a contention window (CW)) and determining whether the shared or unlicensed channel is free or busy based at least in part on the signals sensed or measured on the physical channel (for example, based at least in part on whether the measurement satisfies a threshold). If the transmitting device determines that the channel access procedure was successful (for example, if the measurement does not satisfy the threshold), then the transmitting device may perform one or more transmissions on the shared or unlicensed channel during a transmission opportunity, which may extend for a channel occupancy time (COT). If the transmitting device determines that the channel access procedure was unsuccessful (for example, if the measurement satisfies the threshold), then the transmitting device may refrain from performing one or more transmissions on the shared or unlicensed channel. A channel access procedure that is unsuccessful may be referred to as a “failure” (for example, a channel access failure or an LBT failure).

In some examples, a frequency band size for an unlicensed frequency band may be large (for example, larger than 20 MHz). In such examples, the band may be partitioned into one or more RB sets (for example, where an RB set includes one or more contiguous RBs within the band). A resource pool configured for a UE for sidelink communications via an unlicensed frequency band may include one or more RB sets. Each RB set can be divided into a set of subchannels and each subchannel can be divided into a set of RBs. A transmitting device (for example, a UE) may perform a channel access procedure (for example, an LBT procedure) on a given RB set (for example, may measure or sense a channel for frequency domain resources associated with the given RB set, rather than for the entire frequency band) to access one or more subchannels included in the given RB set. In some examples, for wideband transmissions, the transmitting device may perform the channel access procedure on multiple RB sets.

For example, selection of sidelink resources, via the MAC layer and the PHY layer for a Mode 2 UE, can occur over a resource pool. For example, a set of LsubcH contiguous subchannels can be selected for a single-slot resource. In an unlicensed channel, each resource pool can be divided into a set of RB sets (LBT channels). Each RB set can be divided into a set of subchannels and each subchannel can be divided into a set of RBs. To use subchannels within an RB set, a related LBT procedure can be successfully performed by the UE. The more RB sets that are spanned in the resource selection (for example, the more RB sets that are at least partially overlapping with the selected LsubCH contiguous subchannels), the less likely it is that all required LBTs are to be successful.

In some examples, a UE may experience a persistent LBT failure. “Persistent LBT failure” may refer to a scenario where the UE repeatedly fails to access a shared or unlicensed communication channel (for example, a channel associated with a shared or unlicensed frequency band) due to LBT failures or other channel access procedure failures. For example, a persistent LBT failure may be based on, or otherwise associated with, a rate of LBT failures experienced by the UE. In some examples, a UE may detect a persistent LBT failure based on, in response to, or otherwise associated with a quantity of LBT failures, over a given time interval, satisfying a persistent LBT failure threshold. The UE may generate a persistent LBT failure report based on, in response to, or otherwise associated with to detecting a persistent LBT failure. The persistent LBT failure report may be a MAC layer report that triggers the UE to perform one or more operations. For example, for access link (for example, Uu link) communications, the persistent LBT failure report may trigger a radio link failure (RLF). Additionally or alternatively, for access link (for example, Uu link) communications, the persistent LBT failure report may cause the UE to adjust one or more parameters of future transmissions, to attempt to mitigate future LBT failures.

As described elsewhere herein, for sidelink communications, a UE may perform an LBT operation by sensing resources associated with one or more RB sets. A resource pool configured for the UE may include multiple RB sets. The persistent LBT failure report may be associated with an RB set level granularity or a resource-pool-level granularity. In some examples, the persistent LBT failure report may indicate that a quantity of LBT failures associated with at least one RB set of a configured resource pool satisfies the persistent LBT failure threshold. For example, if the persistent LBT failure report is associated with the RB set level granularity, then the persistent LBT failure report may indicate a likelihood of LBT success associated with each RB set. For example, the persistent LBT failure report may indicate a ratio of a quantity of LBT failures to a quantity of LBT attempts over a moving window for a given RB set. In other examples, if the persistent LBT failure report is associated with the resource-pool-level granularity, then the persistent LBT failure report may indicate a likelihood of LBT success associated with a given resource pool. For example, the persistent LBT failure report may indicate that a quantity of LBT failures, associated with any RB set included in the resource pool, over a given time interval (for example, a sliding time window) satisfies the persistent LBT failure threshold. In other words, an LBT failure associated with any one of multiple RB sets included in a resource pool will contribute to an LBT failure count for the resource pool. If the LBT failure count, over the given time interval (for example, a sliding time window) satisfies the persistent LBT failure threshold, then the UE may generate and/or transmit a persistent LBT failure report for the resource pool.

However, operations to be performed by the UE in response to a resource-pool-level persistent LBT failure report are not defined. For example, if a resource-pool-level persistent LBT failure report is generated, the UE may be unable to identify which RB set(s) are experiencing LBT failures (for example, because the resource-pool-level persistent LBT failure report may be generated for LBT failures associated with any RB set included in the resource pool). Therefore, the UE may continue to use the resource pool to select resources for future sidelink transmissions without a knowledge of which RB set(s) are experiencing LBT failures.

For example, the UE may continue to attempt to access an unlicensed channel or frequency band using RB set(s), included in the resource pool, that are experiencing LBT failures (for example, because the UE is unable to identify which RB set(s) are experiencing LBT failures). This may result in the UE being unable to access the unlicensed channel or frequency band for sidelink transmissions. As a result, the UE may experience increased latency, data loss, and/or reduced performance, among other examples, associated with attempted sidelink transmissions via the unlicensed channel or frequency band.

Various aspects relate generally to operations for persistent resource-pool-based LBT failures. Some aspects more specifically relate to defining the operations to be performed by a UE in response to a resource-pool-level persistent LBT failure report to mitigate future LBT failures. In some aspects, an operation in response to a resource-pool-level persistent LBT failure report for a given resource pool may include refraining from attempting sidelink transmissions via the given resource pool. For example, the UE may direct traffic, that would have otherwise been attempted to be transmitted via the given resource pool, to one or more alternative resource pools.

In some aspects, one or more parameters may be defined for a selection of an alternative resource pool in response to a resource-pool-level persistent LBT failure report. For example, the UE may select the one or more alternative resource pools based on, or otherwise associated with, the one or more parameters. The one or more parameters may include a size of a frequency domain overlap between the one or more alternative resource pools and the given resource pool (for example, that is associated with the persistent LBT failure). Additionally or alternatively, the one or more parameters may include a comparison of one or more configuration parameters for the one or more alternative resource pools and the given resource pool. The one or more configuration parameters may include radio resource parameters (for example a quantity of time domain resources and/or a quantity of frequency domain resources) and/or feature parameters (for example, a PSFCH configuration), among other examples.

In some aspects, one or more parameters may be defined for a UE to determine when a use of a resource pool, that is associated with a resource-pool-level persistent LBT failure report, may be resumed after stopping the use due to the resource-pool-level persistent LBT failure report. For example, the one or more parameters may include a timer (for example, an amount of time from detecting the persistent LBT failure). Additionally or alternatively, the one or more parameters may be associated with an activity level associated with the resource pool.

Particular aspects of the subject matter described in this disclosure can be implemented to realize one or more of the following potential advantages. In some examples, the described techniques can be used to enable a UE to handle a resource-pool-level persistent LBT failure when operating in Mode 2 (for example, without assistance of a network node). For example, stopping a use of a resource pool associated with a persistent LBT failure and directing sidelink traffic to one or more alternative resource pools reduces latency associated with the sidelink traffic, reduces a likelihood that the UE experiences an LBT failure when attempting to transmit the sidelink traffic, and/or reduces a likelihood of losing or dropping the sidelink traffic (for example, due to being unable to access an unlicensed or shared channel), among other examples. Additionally, defining one or more parameters for selecting an alternative resource pool reduces a likelihood that the alternative resource pool is associated with similar LBT failures and/or improves a likelihood that the alternative resource pool supports similar configuration parameters as the resource pool that is associated with the persistent LBT failure. Further, defining one or more parameters for resuming a use of a resource pool that is associated with the persistent LBT failure enables the UE to use the resource pool (for example, thereby improving resource utilization) while also reducing a likelihood that the UE will continue to experience LBT failures when resuming the use of the resource pool.

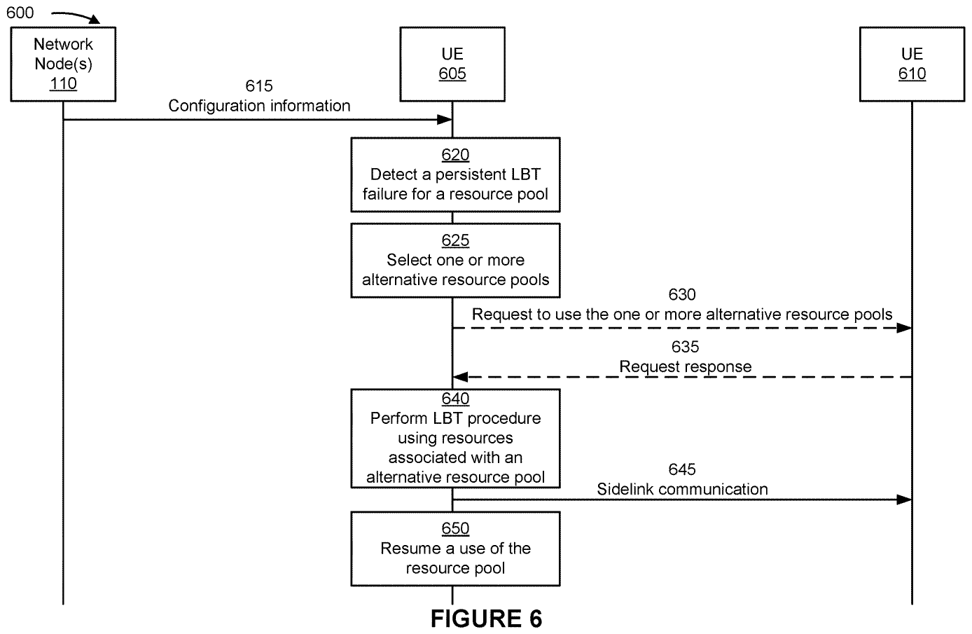

FIG. 6 is a diagram of an example associated with operations 600 for persistent resource-pool-based LBT failures in accordance with the present disclosure. As shown in FIG. 6, one or more network nodes 110 (for example, a base station, a CU, a DU, and/or an RU) may communicate with a UE 605 (for example, a UE 120) and/or a UE 610 (for example, a UE 120). In some aspects, the network node 110 and the UE 605 (and/or the UE 610) may be part of a wireless network (for example, the wireless network 100). The UE 605 and the network node 110 may have established a wireless connection prior to operations shown in FIG. 6.

The UE 605 and the UE 610 may communicate via a sidelink (for example, in a similar manner as described above in connection with FIGS. 4 and 5). In some aspects, the UE 605 may operate in the Mode 2. For example, the UE 605 may operate using a transmission mode (for example, the Mode 2) where resource selection and/or scheduling is performed by the UE 605 (for example, rather than by the network node 110). In some aspects, the UE 605 and the UE 610 may communicate via an unlicensed (or shared) frequency band (for example, an unlicensed (or shared) sidelink channel), in a similar manner as described in more detail elsewhere herein.

In a first operation 615, the network node 110 may transmit, and the UE 605 may receive, configuration information. In some aspects, the UE 605 may receive the configuration information via one or more of system information signaling, RRC signaling, one or more MAC control elements (MAC-CEs), and/or DCI, among other examples. In some aspects, the configuration information may include an indication of one or more configuration parameters for selection by the UE 605, and/or explicit configuration information for the UE 605 to use to configure itself, among other examples. In some aspects, the UE 610 may receive similar configuration information (for example, from the network node 110 or from another network node 110) as described herein in connection with the UE 605.

In some aspects, the configuration information may indicate multiple resource pools associated with sidelink communications for a shared frequency band. For example, the configuration information may include a configuration that indicates one or more resource pools that are available to be used by the UE 605 via the shared frequency band. For example, the UE 605 may obtain or receive a sidelink configuration indicating information and/or parameters associated with communicating via a sidelink channel (for example, a shared or unlicensed sidelink channel). For example, the UE 605 may receive the sidelink configuration from the network node 110 (for example, via an RRC configuration). As another example, the UE 605 may receive the sidelink configuration from another UE (for example, via a sidelink RRC configuration). In some cases, the sidelink configuration (or a portion of the sidelink configuration) may be stored in a memory of the UE 605 prior to the UE 605 communicating with a network node 110 or another UE (for example, the UE 605 may be pre-configured with the sidelink configuration or a portion of the sidelink configuration, such as in an original equipment manufacturer (OEM) configuration).

Some sidelink configuration parameters or configuration fields described herein may be defined, or otherwise fixed, by a wireless communication standard, such as the 3GPP. For example, the sidelink configuration may include a sidelink frequency configuration (SL-FreqConfig). For example, the SL-FreqConfig may indicate that the UE 605 is to use the shared frequency band. The SL-FreqConfig may indicate dedicated configuration information on one particular carrier frequency for sidelink communication. The SL-FreqConfig may indicate configuration information, such as a frequency location of a sidelink SSB (for example, via an sl-AbsoluteFrequencySSB field), a list of sidelink BWPs on which the sidelink communication configuration is to be added or reconfigured (for example, via an sl-BWP-ToAddModList field), a list of sidelink BWPs on which the sidelink communication configuration is to be released (for example, via an sl-BWP-ToReleaseList field), an identifier of the dedicated configuration information on the carrier frequency for sidelink communication (for example, via an sl-Freq-Id field), and/or one or more UE specific channel bandwidth and location configurations for different SCSs (for example, numerologies) that are defined in relation to Point A (for example, via an sl-SCS-SpecificCarrierList field), among other examples.

The sidelink configuration may include a sidelink BWP configuration (for example, an SL-BWP-Config). The SL-BWP-Config may indicate UE specific configuration information for sidelink communication on one particular sidelink BWP. For example, the SL-BWP-Config may include a generic BWP configuration (for example, in an sl-BWP-Generic field). The generic BWP configuration may indicate one or more generic parameters on the configured sidelink BWP, such as a bandwidth size of the BWP, a frequency location (for example, relative to the Point A) of the BWP, a numerology (for example, an SCS and/or CP, among other examples) of the BWP, time domain resource(s) associated with the BWP, a quantity of symbols used for sidelink in a slot without a sidelink SSB, a starting symbol used for sidelink in a slot without a sidelink SSB, and/or a subcarrier index within the carrier corresponding to the numerology of the corresponding sidelink BWP indicating a sidelink Tx/Rx direct current location for the carrier, among other examples.

The SL-BWP-Config may indicate resource pool configurations associated with one particular sidelink BWP (for example, via an sl-BWP-PoolConfig IE, an SL-ResourcePool IE, and/or an SL-ResourcePoolConfig IE). For example, the resource pool configurations may include one or more resource pool configurations associated with sidelink transmissions for the Mode 2, and/or resource pool configurations associated with sidelink receptions, among other examples.

For example, an SL-ResourcePool IE (or an SL-ResourcePoolConfig IE) may indicate configuration information for a given sidelink communication resource pool available to be used for the shared frequency band. The SL-ResourcePool IE may indicate one or more sidelink physical channel configurations for the resource pool (for example, an SL-PSCCH-Config, an SL-PSSCH-Config, and/or an SL-PSFCH-Config, among other examples). Additionally or alternatively, the SL-ResourcePool IE may indicate a quantity of subchannels associated with the resource pool (for example, via an sl-NumSubchannel field), a subchannel size (for example, in terms of a quantity of RBs)) of the subchannels associated with the resource pool (for example, via an sl-SubchannelSize field), and/or a starting RB associated with the resource pool (for example, via an sl-StartRB-Subchannel field), among other examples. Additionally or alternatively, the SL-ResourcePool IE may indicate a time window size for CBR measurement associated with the resource pool (for example, via an sl-Time WindowSizeCBR field), one or more MCSs associated with the resource pool (for example, via an SL-MinMaxMCS-Config IE and/or an sl-MCS-Table field), a sensing configuration associated with the resource pool (for example, via an sl-RS-ForSensing field, and/or an sl-SensingWindow field, among other examples), and/or a power control configuration associated with the resource pool (for example, via an SL-PowerControl IE), among other examples. The SL-ResourcePool IE may indicate additional configuration information, configuration parameters, and/or configuration fields. For example, the configuration information may indicate multiple resource pool configurations (for example, multiple SL-ResourcePool IEs) that are available for the UE 605 to use for transmitting communications via the shared frequency band.

In some aspects, the configuration information may indicate whether a given resource pool is a common resource pool or a cell-specific resource pool. For example, a common sidelink BWP configuration (for example, a common SL-BWP-Config that is configured for multiple UEs including the UE 605 and the UE 610) may indicate one or more common resource pools or cell-specific resource pools. “Common” resource pool or “cell-specific” resource pool may refer to a resource pool that is configured for both transmitting and receiving operations (for example, for multiple UEs including the UE 605 and the UE 610).

In some aspects, a configuration of a resource pool may indicate whether the resource pool can be used as a fallback resource pool for resource pools associated with persistent LBT failures. “Fallback resource pools” may be referred to as “alternative” resource pools herein. For example, a configuration of a resource pool may include a flag associated with indicating whether the resource pool is available to be used as an alternative resource pool for communications associated with another resource pool that is experiencing a persistent LBT failure. For example, if the flag is set to “true”, then the UE 605 may identify that the resource can be used as an alternative resource pool. In some aspects, a sidelink BWP configuration (for example, an SL-U BWP configuration) may indicate one or more resource pool identifiers (for example, one or more resource pool indices) that are available to be used as alternative resource pools for communications associated with another resource pool that is experiencing a persistent LBT failure. For example, the sidelink BWP configuration may indicate a list of indexes corresponding to respective configured cell-specific resource pools that are to be used as alternative resource pools.

In some aspects, the configuration information may indicate that one or more configured resource pools are to be used only as alternative resource pools. For example, the configuration information may indicate that one or more configured resource pools are to be used only for the purpose of being a fallback for another resource pool that is experiencing a persistent LBT failure (for example, only for recovering persistent LBT failures). In some aspects, such resource pools may be configured (for example, semi-statically) to ensure a match between UEs that receive the configuration information (for example, due to being in a coverage area of the network node 110) and UEs that operate without receiving the configuration information.

In some aspects, the configuration information may indicate a configuration of one or more exceptional resource pools. “Exceptional” resource pool may refer to a resource pool that is configured for a given use and/or a given service or application. An exceptional resource pool enables communications and/or services to access and use radio resources even when the network is congested, and other users may be experiencing degraded service. As another example, the exceptional resource pool enables communications and/or services to access and use radio resources when a transmitter is unaware of, or have a clear understanding of, which resource pool to use for the communications and/or services. The purpose of the exceptional resource pool is to ensure that high priority communications and/or services have access to reliable communication channels, even in situations where the network is heavily loaded or experiencing disruptions. By providing dedicated resources that are reserved for high-priority communications and/or services, an exceptional resource pool can help to ensure that high priority communications are not impacted by other less urgent traffic.

For example, the configuration information may include an sl-TxPoolExceptional IE that configures an exceptional resource pool (for example, via an SL-U BWP configuration). For example, an exceptional resource pool may be associated with sidelink communications having a priority and/or use that meets criteria indicated by the sl-TxPoolExceptional IE. For example, an exceptional resource pool may be used by the UE 605 for public safety or emergency services, one or more logical channels, RRC reconfiguration communications, RLF communications, and/or RRC connection reestablishment communications, among other examples. In some aspects, the configuration information may indicate that the exceptional resource pool is available for use by the UE 605 when the UE 605 detects a persistent LBT failure associated with a configured resource pool. For example, the configuration information may indicate that the UE 605 is to fall back, from a resource pool (for example, a Tx resource pool and/or a dedicated resource pool), to the exceptional resource pool in response to a persistent LBT failure report associated with the resource pool.

In some aspects, a sidelink BWP for the UE 605 may be associated with a first exceptional resource pool (for example, associated with public safety or emergency services, one or more logical channels, RRC reconfiguration communications, RLF communications, RRC connection reestablishment communications, and/or other high priority communications) and a second exceptional resource pool (for example, associated with being an alternative resource pool for resource pools associated with persistent LBT failures). In other words, the configuration information may configure a dedicated exceptional resource pool associated with being a fallback for resource pools associated with persistent LBT failures.

In some aspects, the configuration information may indicate that the first exceptional resource pool is to be associated with random selection for resource selection (for example, the UE 605 may not perform sensing associated with the first exceptional resource pool and may randomly select resources from the first exceptional resource pool to use for sidelink transmissions). The configuration information may indicate that the second exceptional resource pool is to be associated with sensing for resource selection (for example, the UE 605 may perform sensing associated with the second exceptional resource pool and may select resources from the second exceptional resource pool to use for sidelink transmissions based on, or otherwise associated with, the sensing results). For example, all UEs configured with the first exceptional resource pool and the second exceptional resource pool may be expected to monitor both exceptional resource pools. In some aspects, the configuration information may indicate that both the first exceptional resource pool and the second exceptional resource pool are available to be used as fallback resource pools for resource pools associated with persistent LBT failures.

In some aspects, the configuration information may indicate one or more parameters for selecting an alternative resource pool. In some aspects, the configuration information may indicate that the UE 605 is to select an alternative resource pool having no (or a minimal) frequency domain overlap with the resource pool associated with a persistent LBT failure and/or is to select an alternative resource pool having a similar (or the same) configuration as the resource pool associated with a persistent LBT failure, among other examples. For example, the one or more parameters may include an allowable frequency domain overlap between a resource pool experiencing a persistent LBT failure and an alternative resource pool. For example, the configuration information may indicate an overlap threshold. The configuration information may indicate that an alternative resource pool may be selected based on, or otherwise associated with, a frequency domain overlap between frequency domain resources of a resource pool experiencing a persistent LBT failure and frequency domain resources of the alternative resource pool satisfying (for example, being less than or equal to) the overlap threshold. In some aspects, the configuration information may indicate that an alternative resource pool may be selected based on, or otherwise associated with, there being no frequency domain overlap between frequency domain resources of a resource pool experiencing a persistent LBT failure and frequency domain resources of the alternative resource pool.

In some aspects, the one or more parameters may include a comparison of a first configuration of a first resource pool (for example, that is associated with a persistent LBT failure) and a second configuration of a second resource pool (for example, a candidate alternative resource pool). For example, the comparison of the first configuration and the second configuration may be associated with a comparison of radio resources (for example, frequency domain resources and/or time domain resources) indicated by the first configuration and the second configuration. For example, the configuration information may indicate that the second resource pool may be selected as the alternative resource pool (for example, alternative to the first resource pool) based on, or otherwise associated with, a difference between a quantity of radio resources (for example, a quantity of RBs, a quantity of subchannels, and/or a quantity of logical slots or symbols within a frame) configured for the first resource pool and a quantity of radio resources configured for the second resource pool satisfying a resource threshold. For example, the configuration information may indicate that the quantity of radio resources associated with the second resource pool is to be equal to or greater than X% of the radio resources associated with the first resource pool (for example, where a value of X is indicated by the configuration information) for the second resource pool to be selected as an alternative resource pool.

In some aspects, the comparison of the first configuration and the second configuration may be associated with a comparison of configured features. For example, the configuration information may indicate that if one or more features are configured for the first resource pool, then only resource pools also being configured with the one or more features are available to be selected as an alternative resource pool (for example, alternative to the first resource pool). For example, the one or more features may include feedback being enabled for the first resource pool (for example, the first resource pool being associated with a configured PSFCH). For example, if the first resource pool supports a PSFCH, then only resource pools that also support a PSFCH may be selected as an alternative resource pool (for example, alternative to the first resource pool). In some aspects, the configuration information may indicate that the second resource pool may be selected as the alternative resource pool based on, or otherwise associated with, a difference between a PSFCH period configured for the first resource pool and a PSFCH period configured for the second resource pool satisfying a PSFCH period threshold.

In some aspects, the configuration information may indicate a prioritization between having a frequency domain overlap, between the first resource pool and the second resource pool, that is less than or equal to the overlap threshold, and a comparison of a first configuration of the first resource pool and a second configuration of the second resource pool. In other words, the configuration information may indicate whether the UE 605 is to prioritize selecting an alternative resource pool having no (or a minimal) frequency domain overlap with the resource pool associated with a persistent LBT failure or is to prioritize selecting an alternative resource pool having a similar (or the same) configuration as the resource pool associated with a persistent LBT failure.

The UE 605 may configure itself based at least in part on the configuration information. In some aspects, the UE 605 may be configured to perform one or more operations described herein based at least in part on the configuration information. The UE 610 may be configured in a similar manner as described herein.

The UE 605 and the UE 610 may establish a link (for example, a communication link via the sidelink shared frequency band) via a first resource pool. For example, the UE 605 and the UE 610 may communicate in the Mode 2. The first resource pool may be a Tx resource pool configured for the UE 605. For example, the first resource pool may be a dedicated resource pool configured for the UE 605.

In a second operation 620, the UE 605 may detect a persistent LBT failure for the first resource pool. For example, the UE 605 may detect the persistent LBT failure based on, or otherwise associated with, one or more LBT failures via resources associated with the first resource pool. For example, the UE 605 may detect that a quantity of LBT failures (for example, associated with RB set(s) or subchannel(s) included in the first resource pool) over a time interval satisfies a persistent LBT failure threshold. A value of the persistent LBT failure threshold may be indicated by the configuration information and/or may be defined, or otherwise fixed, by a wireless communication standard, such as the 3GPP. For example, a PHY layer of the UE 605 may report, to a MAC layer of the UE 605, information indicating the LBT failures. The MAC layer may generate an LBT failure report based on, or otherwise associated with, detecting the persistent LBT failure for the first resource pool. For example, the LBT failure report may be associated with a resource-pool-level granularity, as described in more detail elsewhere herein.

The generation of the LBT failure report may cause (for example, may trigger) the UE 605 to perform one or more operations described herein, such as a third operation 625, a fourth operation 630, a fifth operation 635, a sixth operation 640, a seventh operation 645, and/or an eighth operation 650, among other examples, as described in more detail below. In some aspects, the UE 605 may transmit (for example, to the UE 610 and/or the network node 110) an indication of the LBT failure report. In other examples, the LBT failure report may be generated by the UE 605 (for example, in the MAC layer of a protocol stack of the UE 605) and may not be transmitted or provided to another device.

In the third operation 625, the UE 605 may select one or more alternative resource pools. For example, the one or more alternative resource pools may be fallback resource pools to be used instead of the first resource pool. Although examples below are described in connection with the UE 605 selecting a single alternative resource pool (for example, a second resource pool), in some cases the UE 605 may select multiple alternative resource pools in a similar manner.

For example, the UE 605 may select a second resource pool to be the alternative resource pool for the first resource pool. In some aspects, the UE 605 may select the second resource pool based on, or otherwise associated with, information and/or parameters indicated by the configuration information, as described elsewhere herein. Additionally or alternatively, the UE 605 may select the second resource pool based on, or otherwise associated with, information stored by the UE 605 (for example, pre-configured or stored in an OEM configuration).

In some aspects, the UE 605 may select the second resource pool based on, or otherwise associated with, a comparison of first frequency domain resources associated with the first resource pool and second frequency domain resources associated with the second resource pool. For example, the UE 605 may select the second resource pool based on, or otherwise associated with, the first frequency domain resources and the second frequency domain resources not overlapping. As another example, the UE 605 may select the second resource pool based on, or otherwise associated with, a frequency domain overlap between the first resource pool and the second resource pool satisfying the overlap threshold.

In some aspects, the UE 605 may select the second resource pool based on, or otherwise associated with, a frequency domain overlap between the first frequency domain resources and the second frequency domain resources being a smallest frequency domain overlap among frequency domain overlaps between respective frequency domain resources of the multiple resource pools and the first frequency domain resources. In other words, the UE 605 may select a resource pool (for example, from configured resource pools for the UE 605) having the smallest available overlap in frequency with the first resource pool (for example, if there are no configured resource pools having no frequency domain overlap with the first resource pool).

In some aspects, the UE 605 may select the second resource pool based on, or otherwise associated with, the second resource pool being comparable to the first resource pool. For example, the UE 605 may select the second resource pool based on, or otherwise associated with, a first configuration of the first resource pool and a second configuration of the second resource pool (for example, indicated by the configuration information in the first operation 615). For example, the UE 605 may select the second resource pool based on, or otherwise associated with, the second resource pool having a similar (or the same) radio resource configuration as the first resource pool and/or based on, or otherwise associated with, the second resource pool supporting similar (or the same) features as the first resource pool. For example, the UE 605 may select the second resource pool based on, or otherwise associated with, a difference between first radio resources (for example, a quantity of RBs, a quantity of RB sets, a quantity of subchannels, and/or a quantity of logical slots) indicated by the first configuration and second radio resources indicated by the second configuration satisfying a threshold. For example, the UE 605 may select the second resource pool based on, or otherwise associated with, a quantity of the first radio resources and a quantity of the second radio resources being equal. As another example, the UE 605 may select the second resource pool based on, or otherwise associated with, the quantity of the second radio resources being greater than or equal to the quantity of the first radio resources. As another example, the UE 605 may select the second resource pool based on, or otherwise associated with, the quantity of the second radio resources being greater than or equal to X% of the quantity of the first radio resources.

Additionally or alternatively, the UE 605 may select the second resource pool based on, or otherwise associated with, the second resource pool supporting similar (or the same) features as the first resource pool. For example, the UE 605 may select the second resource pool based on, or otherwise associated with, one or more features indicated by the first configuration being indicated by the second configuration (for example, of the second resource pool). For example, the one or more features may include support for a PSFCH. In some aspects, the UE 605 may select the second resource pool based on, or otherwise associated with, the second resource pool having a similar PSFCH configuration as a PSFCH configuration the first resource pool. For example, the UE 605 may select the second resource pool based on, or otherwise associated with, a difference between a first PSFCH period of the PSFCH configuration of the first resource pool and a second PSFCH period of a PSFCH configuration of the second resource pool satisfying a PSFCH period threshold.

In some aspects, the UE 605 may select the second resource pool based on, or otherwise associated with, first identifying resource pools with no frequency domain overlap with the first resource pool. If there is a single resource pool (for example, the second resource pool) having no frequency domain overlap with the first resource pool, then the UE 605 may select the single resource pool as the alternative resource pool. If there are multiple resource pools having no frequency domain overlap with the first resource pool, then the UE 605 may compare configurations of the multiple resource pools to the configuration of the first resource pool and select a resource pool (from the multiple resource pools) having the most comparable configuration to the first resource pool. If there are no configured resource pools having no frequency domain overlap with the first resource pool, then the UE 605 may compare configurations of the multiple resource pools configured for the UE 605 to the configuration of the first resource pool and select a resource pool (from the multiple resource pools) having the most comparable configuration to the first resource pool. In some aspects, the UE 605 may balance or prioritize between selecting an alternative resource pool having a smallest frequency domain overlap with the first resource pool and selecting an alternative resource pool having the most similar configuration to the configuration of the first resource pool. For example, there may be a third resource pool with a smallest frequency domain overlap with the first resource pool and a fourth resource pool with a most comparable or similar configuration to the configuration of the first resource pool. The UE 605 may select the third resource pool or the fourth resource pool (for example, the third resource pool or the fourth resource pool may be the second resource pool described elsewhere herein) based on, or otherwise associated with, whether the UE 605 is prioritizing minimizing the frequency domain overlap or prioritizing having a comparable configuration when selecting the alternative resource pool(s).

In some aspects, the UE 605 may select the second resource pool based on, or otherwise associated with, the second resource pool being a common resource pool or a cell-specific resource pool. This may ensure that other UEs (for example, the UE 610) are monitoring the second resource pool. For example, if the configuration information (for example, a common sidelink BWP configuration) indicates one or more cell-specific or common resource pools, then the UE 605 may select the alternative resource pool from the one or more cell-specific or common resource pools (for example, considering other factors described elsewhere herein).

In some aspects, the UE 605 may select the second resource pool based on, or otherwise associated with, a configuration of the second resource pool (for example, a flag in the configuration) indicating that the second resource pool is available to be used as an alternative resource pool. For example, a configuration of a cell-specific resource pool may have an associated flag which, when set to true, means that this resource pool can be safely utilized by the UE 605 as an alternative resource pool when experiencing a persistent LBT failure in another resource pool (for example, the first resource pool).

In some aspects, the UE 605 may select the second resource pool based on, or otherwise associated with, the second resource pool being an exceptional resource pool, as indicated by the configuration information. For example, as described elsewhere herein, all UEs, associated with a given SL-U configuration, may monitor configured exceptional resource pool(s). Therefore, selecting an exceptional resource pool as the alternative resource pool may ensure that other UEs (for example, the UE 610) are monitoring the selected alternative resource pool. In some aspects, the UE 605 may select the exceptional resource pool as the alternative resource pool based on, or otherwise associated with, (for example, only if) there is no frequency domain overlap between the exceptional resource pool and the first resource pool or based on, or otherwise associated with, a frequency domain overlap between the exceptional resource pool and the first resource pool satisfying the overlap threshold. Additionally or alternatively, the UE 605 may select the exceptional resource pool as the alternative resource pool based on, or otherwise associated with, no other resource pools (for example, cell-specific resource pools) being available to be selected as the alternative resource pool.

Additionally or alternatively, the UE 605 may select an exceptional resource pool that is configured for being an alternative resource pool for resource pools, of the multiple resource pools configured for the UE 605, that experience persistent LBT failures (for example, the second exceptional resource pool described elsewhere herein). This may ensure that the use of an exceptional resource pool as an alternative resource pool does not congest traffic for other communications and services (for example, that are communicated via the first exceptional resource pool). In some aspects, the UE 605 may select between the first exceptional resource pool and the second exceptional resource pool based on, or otherwise associated with, similar factors described in more detail elsewhere herein.

In some aspects, the UE 605 may select the second resource pool based on, or otherwise associated with, communicating with another UE, such as the UE 610. For example, the UE 610 may be an intended recipient of a communication to be transmitted by the UE 605. The communication may be associated with the first resource pool (for example, a logical channel of the communication may be mapped to the first resource pool or the UE 605 may otherwise determine that the communication is to be transmitted via the first resource pool). However, because of the persistent LBT failure associated with the first resource pool, the UE 605 may select an alternative resource pool (for example, the second resource pool) to be used to transmit the communication. The UE 605 may communicate with the UE 610 to indicate an intent to “transfer” a transmission of the communication from the first resource pool to the second resource pool (for example, when the UE 605 is unaware if the UE 610 can monitor the second resource pool). For example, the UE 605 may communicate with the UE 610 based on, or otherwise associated with, there being no available common or cell-specific resource pools to be selected as the alternative resource pool (for example, to ensure that the UE 610 is able to monitor for and receive the communication to be transmitted via the selected alternative resource pool).

For example, in the fourth operation 630, the UE 605 may transmit, and the UE 610 may receive, a request to use the one or more selected alternative resource pools (for example, the second resource pool). For example, the UE 605 may transmit, and the UE 610 may receive, an indication that the second resource pool is to be used by the UE 605. In some aspects, the indication (for example, the request) may be included in a sidelink radio resource control communication (for example, via a PC5-RRC reconfiguration communication). As another example, the indication (for example, the request) may be included in a UE capability enquiry communication (for example, a UECapabilityEnquirySidelink RRC communication). In some aspects, the indication (for example, the request) may include a list of one or more candidate alternative resource pools. In some aspects, the indication (for example, the request) may be transmitted via resources associated with the first resource pool. In other aspects, the indication (for example, the request) may be transmitted via resources associated with an exceptional resource pool.

In a fifth operation 635, the UE 610 may transmit, and the UE 605 may receive, a request response (for example, confirmation response) to the indication that the second resource pool is to be used by the UE 605. The request response may indicate whether the selected alternative resource pool(s) (for example, the second resource pool) can be used (for example, can be monitored) by the UE 610. For example, the request response may be included in a RRC confirmation response communication. As another example, the request response may be included in a UE capability information communication (for example, a UECapabilityInformationSidelink communication). The UE capability information communication may list and/or rank the alternative resource pools (for example, from the list of one or more candidate alternative resource pools) that the UE 610 can monitor, if any. The UE 605 may select the second resource pool based on, or otherwise associated with, the UE 610 indicating that the UE 610 can monitor the second resource pool. This ensures that the UE 610 is able to receive communications from the UE 605 using the selected alternative resource pool.

In a sixth operation 640, the UE 605 may perform an LBT procedure (or another channel access procedure) using resources associated with an alternative resource pool (for example, the second resource pool). For example, the UE 605 may select the second resource pool to be the alternative resource pool for the first resource pool (for example, that is associated with the persistent LBT failure). The UE 605 may direct sidelink traffic, that would otherwise be communicated via the first resource pool, to be transmitted via the second resource pool. For example, based on, or otherwise associated with, detecting or generating the persistent LBT failure report for the first resource pool, the UE 605 may cause sidelink communications, that would otherwise be communicated via the first resource pool, to be transmitted via the second resource pool (for example, the selected alternative resource pool, as described in more detail in connection with the third operation 625). For example, the UE 605 may detect an arrival of sidelink traffic (for example, associated with, or to be transmitted via, the first resource pool).

The UE 605 may determine that the sidelink traffic is to be transmitted via the second resource pool based on, or otherwise associated with, selecting the second resource pool as an alternative resource pool for the first resource pool and based on, or otherwise associated with, the first resource pool being associated with a persistent LBT failure. The UE 605 may perform an LBT procedure (or another channel access procedure) using resources (for example, an RB set or a subchannel) associated with the second resource pool to attempt to access the shared frequency band or the shared channel. If the LBT procedure is successful, then the UE 605 may transmit a sidelink communication (for example, including the sidelink traffic) using the resources associated with the second resource pool (for example, in the seventh operation 645). If the LBT procedure is unsuccessful (for example, if the LBT procedure fails), then the UE 605 may refrain from transmitting the sidelink communication.

In the seventh operation 645, the UE 605 may transmit, and the UE 610 may receive, the sidelink communication (for example, using resources associated with the second resource pool). For example, the UE 605 may transmit, and the UE 610 may receive, one or more sidelink communications that are associated with the first resource pool (for example, that are intended to be communicated via the first resource pool) using resources of a second resource pool that is selected as an alternative resource pool for the first resource pool, as described in more detail elsewhere herein. For example, the UE 605 may transmit, and the UE 610 may receive, the one or more sidelink communications using the resources of the second resource pool based on, or otherwise associated with, detecting that the first resource pool is associated with the persistent LBT failure (for example, in the second operation 620).

In some aspects, a use of the second resource pool as the alternative resource pool may be limited or restricted. In some aspects, the use of the second resource pool as the alternative resource pool being limited or restricted may be based on, or otherwise associated with, the second resource pool being an exceptional resource pool. For example, the use may be limited or restricted on an exceptional resource pool so as to mitigate a congestion of the channel for other high priority communications and/or services. For example, the exceptional resource pool may be used for sidelink transmissions by the UE 605 in association with one or more conditions being met. In some aspects, the one or more conditions may include an amount of time that the exceptional resource pool has been used by the UE 605 satisfying a time threshold. For example, the amount of time that the exceptional resource pool has been used may include previous usage of the exceptional resource pool by the UE 605 (for example, prior to using the exceptional resource pool as the alternative resource pool). Additionally or alternatively, the amount of time that the exceptional resource pool has been used may include the amount of time that the UE 605 has used the exceptional resource pool as the alternative resource pool. For example, after transmitting a sidelink communication (associated with the first resource pool) using resources associated with the exceptional resource pool (or after selecting the exceptional resource pool as the alternative resource pool), the UE 605 may initiate a timer. After an expiration of the timer, the UE 605 may cease a use of the exceptional resource pool.

As another example, the one or more conditions include a quantity of transmissions by the UE 605 via resources associated with the exceptional resource pool satisfying a transmission threshold. For example, a “transmission” for the purposes of counting the quantity of transmissions may include a transmitted slot, a transmitted transport block, or a transmitted multi-consecutive slot transmission, among other examples. As another example, the one or more conditions may include the first resource pool being unavailable due to the persistent LBT failure. For example, the UE 605 may use the exceptional resource pool as the alternative resource pool until the first resource pool becomes available again (for example, as described in connection with the eighth operation 650). As another example, the one or more conditions may include a congestion level of the exceptional resource pool satisfying a congestion threshold. The congestion level may include a CBR and/or a channel occupancy ratio associated with the exceptional resource pool. This improves a likelihood that other high priority communications may be communicated via the exceptional resource pool, because the UE may refrain from using the exceptional resource pool if the channel becomes too congested (thereby reducing a likelihood that the use of the exceptional resource pool by the UE 605 blocks the communication of the other high priority communications). For example, the UE 605 may be enabled to measure the congestion level of the exceptional resource pool when using the exceptional resource pool as the alternative resource pool.

In the eighth operation 650, the UE 605 may resume a use of the first resource pool. For example, based on, or otherwise associated with, resuming the use of the first resource pool, the UE 605 may no longer direct traffic that is associated with the first resource pool to the one or more alternative resource pools (for example, to the second resource pool). For example, the first resource pool may be available for use for sidelink transmissions, after the persistent LBT failure, associated with one or more conditions being met. In some aspects, the one or more conditions include an amount of time from detecting the persistent LBT failure (for example, in the second operation 620) satisfying a time threshold. For example, after detecting the persistent LBT failure (for example, in the second operation 620), the UE 605 may initiate a timer (for example, a timer associated with the amount of time). After an expiration of the timer, the first resource pool may be available for use by the UE 605. The amount of time associated with the timer may be indicated by the configuration information.

As another example, the one or more conditions may be associated with an activity level of the first resource pool. For example, the activity level may be associated with a channel busy ratio associated with the first resource pool, a quantity of decoding failures associated with the first resource pool, and/or a quantity of negative acknowledgement (NACK) transmissions associated with the first resource pool, among other examples. For example, a CBR measurement of the first resource pool suggesting activity has dropped below a threshold may be a trigger for the UE 605 to resume using the first resource pool again. As another example, if the UE 605 experiences a high decoding failure rate in the first resource pool (for example, for transmissions from other UEs intended for the UE 605, using resources included in the first resource pool), then the UE 605 may identify that the first resource pool is still congested and/or busy. However, if the UE 605 experiences a lower decoding failure rate in the first resource pool (for example, satisfying a decoding failure rate threshold), the UE 605 may identify that the first resource pool is no longer congested and/or busy and may resume a use of the first resource pool. As another example, if a quantity of NACKs transmitted by the UE 605 for communications associated with the first resource pool satisfies a NACK threshold, then the UE 605 may identify that the first resource pool is no longer congested and/or busy and may resume a use of the first resource pool (for example, because NACK transmissions may indicate non-decoded communications by the UE 605).

As another example, the one or more conditions may be associated with an energy sensing level of the first resource pool. For example, the UE 605 may perform sensing (for example, similar to LBT sensing) of the first resource pool over an interval or a series of intervals. The UE 605 may resume a use of the first resource pool based on, in response to, or otherwise associated with the sensing measurements suggesting the first resource pool is no longer congested and/or busy (for example, based on, or otherwise associated with, the sensing measurement satisfying a sensing threshold). The sensing threshold may be the same threshold used for LBT procedures or may be a different sensing threshold. After resuming the use of the first resource pool, the UE 605 may transmit one or more sidelink communications using resources associated with the first resource pool (for example, based on, or otherwise associated with, an LBT procedure associated with the first resource pool being successful).

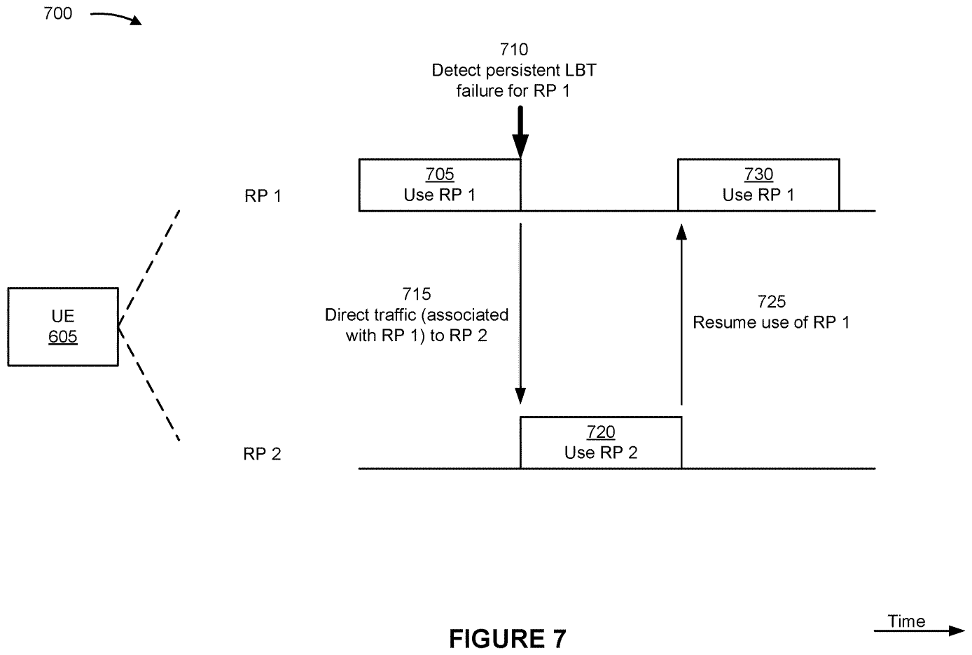

FIG. 7 is a diagram of an example associated with operations 700 for persistent resource-pool-based LBT failures in accordance with the present disclosure. As shown in FIG. 7, the UE 605 may be associated with a first resource pool (RP 1) and a second resource pool (RP 2), in a similar manner as described above in connection with FIG. 6. For example, in a first operation 705, the UE 605 may use the first resource pool for communications (for example, with the UE 610).

In a second operation 710, the UE 605 may detect a persistent LBT failure for the first resource pool. For example, the UE 605 may generate a persistent LBT failure report associated with the first resource pool. The UE 605 may detect the persistent LBT failure in a similar manner as described elsewhere herein, such as in connection with FIG. 6 and/or the second operation 620.

In a third operation 715, the UE 605 may direct traffic, associated with the first resource pool, to a second resource pool. For example, the UE 605 may detect an arrival of sidelink traffic at the UE 605. The UE 605 may determine that the sidelink traffic is intended to be transmitted via the first resource pool. However, because of the persistent LBT failure associated with the first resource pool, the UE 605 may cause the sidelink traffic to be transmitted via the second resource pool. For example, the UE 605 may select the second resource pool as an alternative resource pool for the first resource pool in a similar manner as described elsewhere herein, such as in connection with FIG. 6 and/or the third operation 625. In a fourth operation 720, the UE 120 may use the second resource pool to transmit one or more sidelink communications (for example, that would have otherwise been attempted to be transmitted via the first resource pool). This reduces a latency associated with the one or more sidelink communications, because the first resource pool may have a high likelihood of LBT failure and the second resource pool may be selected to mitigate a risk of LBT failure, as described in more detail elsewhere herein.

In a fifth operation 725, the UE 605 may resume a use of the first resource pool. For example, the UE 605 may resume the use of the first resource pool in a similar manner as described elsewhere herein, such as in connection with FIG. 6 and/or the eighth operation 650. In a sixth operation 730, the UE 605 may transmit one or more sidelink communications using resources associated with the first resource pool (for example, based on, or otherwise associated with, resuming the use of the first resource pool).

FIG. 8 is a flowchart illustrating an example process 800 performed, for example, by a UE that supports operations for persistent resource-pool-based LBT failures in accordance with the present disclosure. Example process 800 is an example where the UE (for example, the UE 120 and/or the UE 605) performs operations associated with operations for persistent resource-pool-based LBT failures.

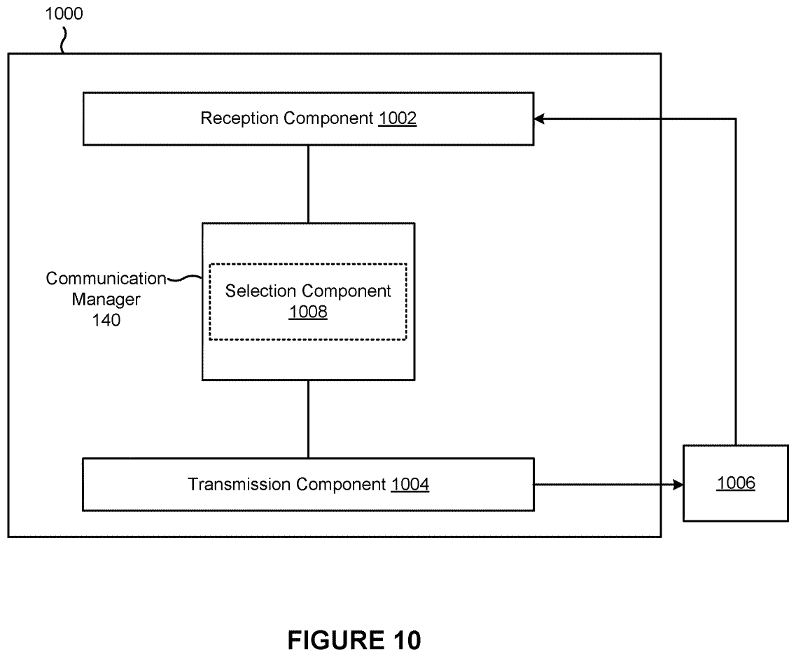

As shown in FIG. 8, in some aspects, process 800 may include receiving configuration information indicating multiple resource pools associated with sidelink communications for a shared frequency band (block 810). For example, the UE (such as by using communication manager 140 or reception component 1002, depicted in FIG. 10) may receive configuration information indicating multiple resource pools associated with sidelink communications for a shared frequency band, as described above.

As further shown in FIG. 8, in some aspects, process 800 may include transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool (block 820). For example, the UE (such as by using communication manager 140 or transmission component 1004, depicted in FIG. 10) may transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool, as described above.

Process 800 may include additional aspects, such as any single aspect or any combination of aspects described below or in connection with one or more other processes described elsewhere herein.

In a first additional aspect, transmitting the one or more sidelink communications using the resources of the second resource pool is associated with a comparison of first frequency domain resources associated with the first resource pool and second frequency domain resources associated with the second resource pool.

In a second additional aspect, alone or in combination with the first aspect, transmitting the one or more sidelink communications using the resources of the second resource pool is associated with the first frequency domain resources and the second frequency domain resources not overlapping.

In a third additional aspect, alone or in combination with one or more of the first and second aspects, transmitting the one or more sidelink communications using the resources of the second resource pool is associated with an overlap between the first frequency domain resources and the second frequency domain resources being a smallest frequency domain overlap among frequency domain overlaps between respective frequency domain resources of the multiple resource pools and the first frequency domain resources.

In a fourth additional aspect, alone or in combination with one or more of the first through third aspects, the configuration information indicates a first configuration of the first resource pool and a second configuration of the second resource pool, and transmitting the one or more sidelink communications using the resources of the second resource pool is associated with the first configuration of the first resource pool and the second configuration of the second resource pool.

In a fifth additional aspect, alone or in combination with one or more of the first through fourth aspects, transmitting the one or more sidelink communications using the resources of the second resource pool is associated with a difference between first radio resources indicated by the first configuration and second radio resources indicated by the second configuration satisfying a threshold.

In a sixth additional aspect, alone or in combination with one or more of the first through fifth aspects, transmitting the one or more sidelink communications using the resources of the second resource pool is associated with one or more features indicated by the first configuration being indicated by the second configuration.

In a seventh additional aspect, alone or in combination with one or more of the first through sixth aspects, the one or more features include support for a physical sidelink feedback channel.

In an eighth additional aspect, alone or in combination with one or more of the first through seventh aspects, transmitting the one or more sidelink communications using the resources of the second resource pool is associated with a prioritization between having a frequency domain overlap, between the first resource pool and the second resource pool, that is less than or equal to an overlap threshold, and a comparison of a first configuration of the first resource pool and a second configuration of the second resource pool.

In a ninth additional aspect, alone or in combination with one or more of the first through eighth aspects, transmitting the one or more sidelink communications using the resources of the second resource pool is associated with the configuration information indicating that the second resource pool is a common resource pool or a cell-specific resource pool.

In a tenth additional aspect, alone or in combination with one or more of the first through ninth aspects, process 800 includes transmitting, to another UE, an indication that the second resource pool is to be used by the UE, and transmitting the one or more sidelink communications using the resources of the second resource pool is associated with transmitting the indication that the second resource pool is to be used by the UE.

In an eleventh additional aspect, alone or in combination with one or more of the first through tenth aspects, the indication that the second resource pool is to be used by the UE is included in a sidelink radio resource control communication.

In a twelfth additional aspect, alone or in combination with one or more of the first through eleventh aspects, the sidelink radio resource control communication is a radio resource control reconfiguration communication.

In a thirteenth additional aspect, alone or in combination with one or more of the first through twelfth aspects, the sidelink radio resource control communication is a UE capability enquiry communication that indicates one or more alternative resource pools, including the second resource pool, that are available to be used by the UE instead of the first resource pool.

In a fourteenth additional aspect, alone or in combination with one or more of the first through thirteenth aspects, process 800 includes receiving, from the other UE, a UE capability information communication indicating one or more resource pools, from the one or more alternative resource pools, that are supported by the other UE, and transmitting the one or more sidelink communications using the resources of the second resource pool is associated with the second resource pool being included in the one or more resource pools.

In a fifteenth additional aspect, alone or in combination with one or more of the first through fourteenth aspects, the indication that the second resource pool is to be used by the UE is communicated using resources associated with the first resource pool.

In a sixteenth additional aspect, alone or in combination with one or more of the first through fifteenth aspects, the configuration information indicates an exceptional resource pool associated with sidelink communications for the shared frequency band, and the indication that the second resource pool is to be used by the UE is communicated using resources associated with the exceptional resource pool.

In a seventeenth additional aspect, alone or in combination with one or more of the first through sixteenth aspects, process 800 includes receiving, from the other UE, a confirmation response to the indication that the second resource pool is to be used by the UE, and transmitting the one or more sidelink communications using the resources of the second resource pool is associated with the confirmation response indicating an acceptance of the use of the second resource pool.

In an eighteenth additional aspect, alone or in combination with one or more of the first through seventeenth aspects, the configuration information indicates an exceptional resource pool associated with sidelink communications for the shared frequency band, and the second resource pool is the exceptional resource pool.

In a nineteenth additional aspect, alone or in combination with one or more of the first through eighteenth aspects, transmitting the one or more sidelink communications using the resources of the second resource pool is associated with a frequency domain overlap between first frequency domain resources of the first resource pool and second frequency domain resources of the exceptional resource pool satisfying an overlap threshold.

In a twentieth additional aspect, alone or in combination with one or more of the first through nineteenth aspects, the exceptional resource pool is used for sidelink transmissions by the UE associated with one or more conditions being met.

In a twenty-first additional aspect, alone or in combination with one or more of the first through twentieth aspects, the one or more conditions include an amount of time that the exceptional resource pool has been used by the UE satisfying a time threshold.

In a twenty-second additional aspect, alone or in combination with one or more of the first through twenty-first aspects, the one or more conditions include a quantity of transmissions by the UE via resources associated with the exceptional resource pool satisfying a transmission threshold.

In a twenty-third additional aspect, alone or in combination with one or more of the first through twenty-second aspects, the one or more conditions include the first resource pool being unavailable due to the persistent LBT failure.

In a twenty-fourth additional aspect, alone or in combination with one or more of the first through twenty-third aspects, the one or more conditions include a congestion level of the exceptional resource pool satisfying a congestion threshold.

In a twenty-fifth additional aspect, alone or in combination with one or more of the first through twenty-fourth aspects, the configuration information indicates that the exceptional resource pool is associated with being an alternative resource pool for resource pools, of the multiple resource pools, that experience persistent LBT failures.

In a twenty-sixth additional aspect, alone or in combination with one or more of the first through twenty-fifth aspects, the configuration information indicates one or more other exceptional resource pools associated with other sidelink operations.

In a twenty-seventh additional aspect, alone or in combination with one or more of the first through twenty-sixth aspects, the configuration information indicates that the second resource pool is available to be used as an alternative resource pool for resource pools, of the multiple resource pools, that experience persistent LBT failures, and transmitting the one or more sidelink communications using the resources of the second resource pool is associated with the configuration information indicating that the second resource pool is available to be used as the alternative resource pool.

In a twenty-eighth additional aspect, alone or in combination with one or more of the first through twenty-seventh aspects, the configuration information indicates that the second resource pool is available to be used only as an alternative resource pool for resource pools, of the multiple resource pools, that experience persistent LBT failures, and transmitting the one or more sidelink communications using the resources of the second resource pool is associated with the configuration information indicating that the second resource pool is available to be used only as the alternative resource pool.

In a twenty-ninth additional aspect, alone or in combination with one or more of the first through twenty-eighth aspects, the first resource pool is available for use for sidelink transmissions, after the persistent LBT failure, associated with one or more conditions being met.

In a thirtieth additional aspect, alone or in combination with one or more of the first through twenty-ninth aspects, the one or more conditions include an amount of time from detecting the persistent LBT failure satisfying a time threshold.

In a thirty-first additional aspect, alone or in combination with one or more of the first through thirtieth aspects, the one or more conditions are associated with an activity level of the first resource pool.

In a thirty-second additional aspect, alone or in combination with one or more of the first through thirty-first aspects, the activity level is associated with at least one of a channel busy ratio of the first resource pool, a quantity of decoding failures associated with the first resource pool, or a quantity of NACK transmissions associated with the first resource pool.

In a thirty-third additional aspect, alone or in combination with one or more of the first through thirty-second aspects, the one or more conditions are associated with an energy sensing level of the first resource pool.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a network node that supports operations for persistent resource-pool-based LBT failures in accordance with the present disclosure. Example process 900 is an example where the network node (for example, network node 110) performs operations associated with operations for persistent resource-pool-based LBT failures.

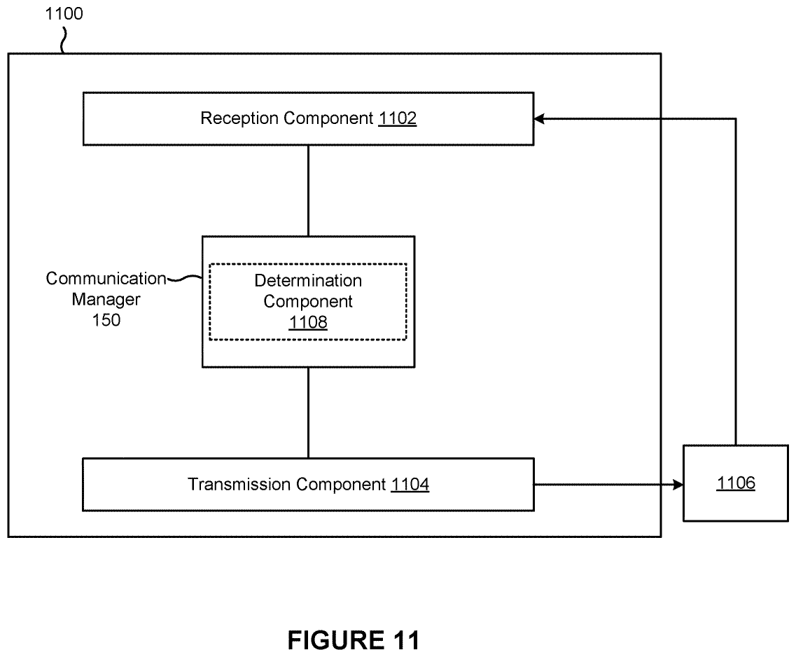

As shown in FIG. 9, in some aspects, process 900 may include transmitting configuration information, associated with a UE, indicating multiple resource pools associated with sidelink communications for a shared frequency band, the configuration information associated with one or more alternative resource pools for resource pool based persistent LBT failures associated with the multiple resource pools (block 910). For example, the network node (such as by using communication manager 150 or transmission component 1104, depicted in FIG. 11) may transmit configuration information, associated with a UE, indicating multiple resource pools associated with sidelink communications for a shared frequency band, the configuration information associated with one or more alternative resource pools for resource pool based persistent LBT failures associated with the multiple resource pools, as described above.

Process 900 may include additional aspects, such as any single aspect or any combination of aspects described below or in connection with one or more other processes described elsewhere herein.

In a first additional aspect, the configuration information indicates a prioritization between having no frequency domain overlap between a resource pool associated with a persistent LBT failure and an alternative resource pool, of the one or more alternative resource pools, and a comparison of a first configuration of the resource pool and a second configuration of the alternative resource pool.

In a second additional aspect, alone or in combination with the first aspect, the configuration information indicates that the one or more alternative resource pools are common resource pools or cell-specific resource pools.

In a third additional aspect, alone or in combination with one or more of the first and second aspects, the configuration information indicates an exceptional resource pool associated with sidelink communications for the shared frequency band, and the one or more alternative resource pools include the exceptional resource pool.

In a fourth additional aspect, alone or in combination with one or more of the first through third aspects, the configuration information indicates that the exceptional resource pool is used for sidelink transmissions associated with one or more conditions being met.

In a fifth additional aspect, alone or in combination with one or more of the first through fourth aspects, the one or more conditions include an amount of time that the exceptional resource pool has been used satisfying a time threshold.

In a sixth additional aspect, alone or in combination with one or more of the first through fifth aspects, the one or more conditions include a quantity of transmissions via resources associated with the exceptional resource pool satisfying a transmission threshold.

In a seventh additional aspect, alone or in combination with one or more of the first through sixth aspects, the one or more conditions include a resource pool, of the multiple resource pools, being unavailable due to a persistent LBT failure.

In an eighth additional aspect, alone or in combination with one or more of the first through seventh aspects, the one or more conditions include a congestion level of the exceptional resource pool satisfying a congestion threshold.

In a ninth additional aspect, alone or in combination with one or more of the first through eighth aspects, the configuration information indicates that the exceptional resource pool is associated with being the one or more alternative resource pools.

In a tenth additional aspect, alone or in combination with one or more of the first through ninth aspects, the configuration information indicates one or more other exceptional resource pools associated with other sidelink operations.

In an eleventh additional aspect, alone or in combination with one or more of the first through tenth aspects, the configuration information indicates that a resource pool, of the multiple resource pools, is available to be used as an alternative resource pool.

In a twelfth additional aspect, alone or in combination with one or more of the first through eleventh aspects, the configuration information indicates that a resource pool, of the multiple resource pools, is available to be used only as an alternative resource pool.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports operations for persistent resource-pool-based LBT failures in accordance with the present disclosure. The apparatus 1000 may be a UE, or a UE may include the apparatus 1000.

In some aspects, the apparatus 1000 includes a reception component 1002, a transmission component 1004, and a communication manager 140, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 6 and 7. Additionally or alternatively, the apparatus 1000 may be configured to and/or operable to perform one or more processes described herein, such as process 800 of FIG. 8. In some aspects, the apparatus 1000 may include one or more components of the UE described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 140. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, and/or a memory of the UE described above in connection with FIG. 2.

The transmission component 1004 may transmit communications, such as reference signals, control information, and/or data communications, to the apparatus 1006. In some aspects, the communication manager 140 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, and/or a memory of the UE described above in connection with FIG. 2. In some aspects, the transmission component 1004 may be co-located with the reception component 1002 in a transceiver.

The communication manager 140 may receive or may cause the reception component 1002 to receive configuration information indicating multiple resource pools associated with sidelink communications for a shared frequency band. The communication manager 140 may transmit or may cause the transmission component 1004 to transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool. In some aspects, the communication manager 140 may perform one or more operations described elsewhere herein as being performed by one or more components of the communication manager 140.

The communication manager 140 may include a controller/processor, a memory, of the UE described above in connection with FIG. 2. In some aspects, the communication manager 140 includes a set of components, such as a selection component 1008, among other examples. Alternatively, the set of components may be separate and distinct from the communication manager 140. In some aspects, one or more components of the set of components may include or may be implemented within a controller/processor, a memory, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive configuration information indicating multiple resource pools associated with sidelink communications for a shared frequency band. The transmission component 1004 may transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent LBT failure, the persistent LBT failure being associated with one or more LBT failures via resources associated with the first resource pool.

The selection component 1008 may select the second resource pool to be an alternative resource pool for the first resource pool. The selection component 1008 may select the second resource pool to be the alternative resource pool associated with one or more criteria.

The transmission component 1004 may transmit, to another UE, an indication that the second resource pool is to be used by the UE, and transmitting the one or more sidelink communications using the resources of the second resource pool may be associated with transmitting the indication that the second resource pool is to be used by the UE.

The reception component 1002 may receive, from the other UE, a UE capability information communication indicating one or more resource pools, from the one or more alternative resource pools, that are supported by the other UE.

The reception component 1002 may receive, from the other UE, a confirmation response to the indication that the second resource pool is to be used by the UE, and transmitting the one or more sidelink communications using the resources of the second resource pool may be associated with the confirmation response indicating an acceptance of the use of the second resource pool.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports operations for persistent resource-pool-based LBT failures in accordance with the present disclosure. The apparatus 1100 may be a network node, or a network node may include the apparatus 1100. In some aspects, the apparatus 1100 includes a reception component 1102, a transmission component 1104, and a communication manager 150, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIGS. 6 and 7. Additionally or alternatively, the apparatus 1100 may be configured to and/or operable to perform one or more processes described herein, such as process 900 of FIG. 9. In some aspects, the apparatus 1100 may include one or more components of the network node described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 150. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, and/or a memory of the network node described above in connection with FIG. 2.

The transmission component 1104 may transmit communications, such as reference signals, control information, and/or data communications, to the apparatus 1106. In some aspects, the communication manager 150 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, and/or a memory of the network node described above in connection with FIG. 2. In some aspects, the transmission component 1104 may be co-located with the reception component 1102 in a transceiver.

The communication manager 150 may transmit or may cause the transmission component 1104 to transmit configuration information, associated with a UE, indicating multiple resource pools associated with sidelink communications for a shared frequency band, the configuration information associated with one or more alternative resource pools for resource pool based persistent LBT failures associated with the multiple resource pools. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a determination component 1108, among other examples. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1104 may transmit configuration information, associated with a UE, indicating multiple resource pools associated with sidelink communications for a shared frequency band, the configuration information associated with one or more alternative resource pools for resource pool based persistent LBT failures associated with the multiple resource pools.

The determination component 1108 may determine the configuration information. The determination component 1108 may determine configurations for the one or more alternative resource pools for resource pool based persistent LBT failures.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configuration information indicating multiple resource pools associated with sidelink communications for a shared frequency band; and transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent listen-before-talk (LBT) failure, the persistent LBT failure being associated with one or more LBT failures via resources associated with the first resource pool.

Aspect 2: The method of Aspect 1, wherein transmitting the one or more sidelink communications using the resources of the second resource pool is associated with a comparison of first frequency domain resources associated with the first resource pool and second frequency domain resources associated with the second resource pool.

Aspect 3: The method of Aspect 2, wherein transmitting the one or more sidelink communications using the resources of the second resource pool is associated with the first frequency domain resources and the second frequency domain resources not overlapping.

Aspect 4: The method of any of Aspects 2-3, wherein transmitting the one or more sidelink communications using the resources of the second resource pool is associated with an overlap between the first frequency domain resources and the second frequency domain resources being a smallest frequency domain overlap among frequency domain overlaps between respective frequency domain resources of the multiple resource pools and the first frequency domain resources.

Aspect 5: The method of any of Aspects 1-4, wherein the configuration information indicates a first configuration of the first resource pool and a second configuration of the second resource pool, and wherein transmitting the one or more sidelink communications using the resources of the second resource pool is associated with the first configuration of the first resource pool and the second configuration of the second resource pool.

Aspect 6: The method of Aspect 5, wherein transmitting the one or more sidelink communications using the resources of the second resource pool is associated with a difference between first radio resources indicated by the first configuration and second radio resources indicated by the second configuration satisfying a threshold.

Aspect 7: The method of any of Aspects 5-6, wherein transmitting the one or more sidelink communications using the resources of the second resource pool is associated with one or more features indicated by the first configuration being indicated by the second configuration.

Aspect 8: The method of Aspect 7, wherein the one or more features include support for a physical sidelink feedback channel.

Aspect 9: The method of any of Aspects 1-8, wherein transmitting the one or more sidelink communications using the resources of the second resource pool is associated with a prioritization between: having a frequency domain overlap, between the first resource pool and the second resource pool, that is less than or equal to an overlap threshold, and a comparison of a first configuration of the first resource pool and a second configuration of the second resource pool.

Aspect 10: The method of any of Aspects 1-9, wherein transmitting the one or more sidelink communications using the resources of the second resource pool is associated with the configuration information indicating that the second resource pool is a common resource pool or a cell-specific resource pool.

Aspect 11: The method of any of Aspects 1-10, further comprising: transmitting, to another UE, an indication that the second resource pool is to be used by the UE, and wherein transmitting the one or more sidelink communications using the resources of the second resource pool is associated with transmitting the indication that the second resource pool is to be used by the UE.

Aspect 12: The method of Aspect 11, wherein the indication that the second resource pool is to be used by the UE is included in a sidelink radio resource control communication.

Aspect 13: The method of Aspect 12, wherein the sidelink radio resource control communication is a radio resource control reconfiguration communication.

Aspect 14: The method of Aspect 12, wherein the sidelink radio resource control communication is a UE capability enquiry communication that indicates one or more alternative resource pools, including the second resource pool, that are available to be used by the UE instead of the first resource pool.

Aspect 15: The method of Aspect 14, further comprising: receiving, from the other UE, a UE capability information communication indicating one or more resource pools, from the one or more alternative resource pools, that are supported by the other UE, and wherein transmitting the one or more sidelink communications using the resources of the second resource pool is associated with the second resource pool being included in the one or more resource pools. wherein transmitting the one or more sidelink communications using the resources of the second resource pool is associated with the second resource pool being included in the one or more resource pools.

Aspect 16: The method of any of Aspects 11-15, wherein the indication that the second resource pool is to be used by the UE is communicated using resources associated with the first resource pool.

Aspect 17: The method of any of Aspects 11-16, wherein the configuration information indicates an exceptional resource pool associated with sidelink communications for the shared frequency band, and wherein the indication that the second resource pool is to be used by the UE is communicated using resources associated with the exceptional resource pool.

Aspect 18: The method of any of Aspects 11-17, further comprising: receiving, from the other UE, a confirmation response to the indication that the second resource pool is to be used by the UE, and wherein transmitting the one or more sidelink communications using the resources of the second resource pool is associated with the confirmation response indicating an acceptance of the use of the second resource pool.

Aspect 19: The method of any of Aspects 1-18, wherein the configuration information indicates an exceptional resource pool associated with sidelink communications for the shared frequency band, and wherein the second resource pool is the exceptional resource pool.

Aspect 20: The method of Aspect 19, wherein transmitting the one or more sidelink communications using the resources of the second resource pool is associated with a frequency domain overlap between first frequency domain resources of the first resource pool and second frequency domain resources of the exceptional resource pool satisfying an overlap threshold.

Aspect 21: The method of any of Aspects 19-20, wherein the exceptional resource pool is used for sidelink transmissions by the UE associated with one or more conditions being met.

Aspect 22: The method of Aspect 21, wherein the one or more conditions include an amount of time that the exceptional resource pool has been used by the UE satisfying a time threshold.

Aspect 23: The method of any of Aspects 21-22, wherein the one or more conditions include a quantity of transmissions by the UE via resources associated with the exceptional resource pool satisfying a transmission threshold.

Aspect 24: The method of any of Aspects 21-23, wherein the one or more conditions include the first resource pool being unavailable due to the persistent LBT failure.

Aspect 25: The method of any of Aspects 21-24, wherein the one or more conditions include a congestion level of the exceptional resource pool satisfying a congestion threshold.

Aspect 26: The method of any of Aspects 19-25, wherein the configuration information indicates that the exceptional resource pool is associated with being an alternative resource pool for resource pools, of the multiple resource pools, that experience persistent LBT failures.

Aspect 27: The method of Aspect 26, wherein the configuration information indicates one or more other exceptional resource pools associated with other sidelink operations.

Aspect 28: The method of any of Aspects 1-27, wherein the configuration information indicates that the second resource pool is available to be used as an alternative resource pool for resource pools, of the multiple resource pools, that experience persistent LBT failures, and wherein transmitting the one or more sidelink communications using the resources of the second resource pool is associated with the configuration information indicating that the second resource pool is available to be used as the alternative resource pool.

Aspect 29: The method of any of Aspects 1-28, wherein the configuration information indicates that the second resource pool is available to be used only as an alternative resource pool for resource pools, of the multiple resource pools, that experience persistent LBT failures, and wherein transmitting the one or more sidelink communications using the resources of the second resource pool is associated with the configuration information indicating that the second resource pool is available to be used only as the alternative resource pool.

Aspect 30: The method of any of Aspects 1-29, wherein the first resource pool is available for use for sidelink transmissions, after the persistent LBT failure, associated with one or more conditions being met.

Aspect 31: The method of Aspect 30, wherein the one or more conditions include an amount of time from detecting the persistent LBT failure satisfying a time threshold.

Aspect 32: The method of any of Aspects 30-31, wherein the one or more conditions are associated with an activity level of the first resource pool.

Aspect 33: The method of Aspect 32, wherein the activity level is associated with at least one of: a channel busy ratio of the first resource pool, a quantity of decoding failures associated with the first resource pool, or a quantity of negative acknowledgement (NACK) transmissions associated with the first resource pool.

Aspect 34: The method of any of Aspects 30-33, wherein the one or more conditions are associated with an energy sensing level of the first resource pool.

Aspect 35: A method of wireless communication performed by a network node, comprising: transmitting configuration information, associated with a user equipment (UE), indicating multiple resource pools associated with sidelink communications for a shared frequency band, the configuration information associated with one or more alternative resource pools for resource pool based persistent listen-before-talk (LBT) failures associated with the multiple resource pools.

Aspect 36: The method of Aspect 35, wherein the configuration information indicates a prioritization between having no frequency domain overlap between a resource pool associated with a persistent LBT failure and an alternative resource pool, of the one or more alternative resource pools, and a comparison of a first configuration of the resource pool and a second configuration of the alternative resource pool.

Aspect 37: The method of any of Aspects 35-36, wherein the configuration information indicates that the one or more alternative resource pools are common resource pools or cell-specific resource pools.

Aspect 38: The method of any of Aspects 35-37, wherein the configuration information indicates an exceptional resource pool associated with sidelink communications for the shared frequency band, and wherein the one or more alternative resource pools include the exceptional resource pool.

Aspect 39: The method of Aspect 38, wherein the configuration information indicates that the exceptional resource pool is used for sidelink transmissions associated with one or more conditions being met.

Aspect 40: The method of Aspect 39, wherein the one or more conditions include an amount of time that the exceptional resource pool has been used satisfying a time threshold.

Aspect 41: The method of any of Aspects 39-40, wherein the one or more conditions include a quantity of transmissions via resources associated with the exceptional resource pool satisfying a transmission threshold.

Aspect 42: The method of any of Aspects 39-41, wherein the one or more conditions include a resource pool, of the multiple resource pools, being unavailable due to a persistent LBT failure.

Aspect 43: The method of any of Aspects 39-42, wherein the one or more conditions include a congestion level of the exceptional resource pool satisfying a congestion threshold.

Aspect 44: The method of any of Aspects 38-43, wherein the configuration information indicates that the exceptional resource pool is associated with being the one or more alternative resource pools.

Aspect 45: The method of Aspect 44, wherein the configuration information indicates one or more other exceptional resource pools associated with other sidelink operations.

Aspect 46: The method of any of Aspects 35-45, wherein the configuration information indicates that a resource pool, of the multiple resource pools, is available to be used as an alternative resource pool.

Aspect 47: The method of any of Aspects 35-46, wherein the configuration information indicates that a resource pool, of the multiple resource pools, is available to be used only as an alternative resource pool.

Aspect 48: An apparatus for wireless communication at a device, comprising a processor; memory coupled with the processor; and instructions stored in the memory and executable by the processor to cause the apparatus to perform the method of one or more of Aspects 1-34.

Aspect 49: A device for wireless communication, comprising a memory and one or more processors coupled to the memory, the one or more processors configured to perform the method of one or more of Aspects 1-34.

Aspect 50: An apparatus for wireless communication, comprising at least one means for performing the method of one or more of Aspects 1-34.

Aspect 51: A non-transitory computer-readable medium storing code for wireless communication, the code comprising instructions executable by a processor to perform the method of one or more of Aspects 1-34.

Aspect 52: A non-transitory computer-readable medium storing a set of instructions for wireless communication, the set of instructions comprising one or more instructions that, when executed by one or more processors of a device, cause the device to perform the method of one or more of Aspects 1-34.

Aspect 53: An apparatus for wireless communication at a device, comprising a processor; memory coupled with the processor; and instructions stored in the memory and executable by the processor to cause the apparatus to perform the method of one or more of Aspects 35-47.

Aspect 54: A device for wireless communication, comprising a memory and one or more processors coupled to the memory, the one or more processors configured to perform the method of one or more of Aspects 35-47.

Aspect 55: An apparatus for wireless communication, comprising at least one means for performing the method of one or more of Aspects 35-47.

Aspect 56: A non-transitory computer-readable medium storing code for wireless communication, the code comprising instructions executable by a processor to perform the method of one or more of Aspects 35-47.

Aspect 57: A non-transitory computer-readable medium storing a set of instructions for wireless communication, the set of instructions comprising one or more instructions that, when executed by one or more processors of a device, cause the device to perform the method of one or more of Aspects 35-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects.

Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a 30 a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
a processing system that includes one or more processors and one or more memories coupled with the one or more processors, the processing system configured to cause the UE to:
receive configuration information indicating multiple resource pools associated with sidelink communications for a shared frequency band; and
transmit, via the shared frequency band, one or more sidelink communications that are associated with a first resource pool, of the multiple resource pools, using resources of a second resource pool of the multiple resource pools, the use of the resources of the second resource pool being associated with the first resource pool having a persistent listen-before-talk (LBT) failure, the persistent LBT failure being associated with one or more LBT failures via resources associated with the first resource pool.

2. The UE of claim 1, wherein the processing system, to transmit the one or more sidelink communications, is configured to cause the UE to compare first frequency domain resources associated with the first resource pool and second frequency domain resources associated with the second resource pool.

3. The UE of claim 1, wherein the configuration information indicates a first configuration of the first resource pool and a second configuration of the second resource pool, and wherein the processing system, to transmit the one or more sidelink communications, is configured to cause the UE to transmit the one or more sidelink communications in association with the first configuration of the first resource pool and the second configuration of the second resource pool.

4. The UE of claim 1, wherein the processing system, to transmit the one or more sidelink communications, is configured to cause the UE to prioritize between:
having a frequency domain overlap, between the first resource pool and the second resource pool, that is less than or equal to an overlap threshold, and
a comparison of a first configuration of the first resource pool and a second configuration of the second resource pool.

5. The UE of claim 1, wherein the processing system, to transmit the one or more sidelink communications, is configured to cause the UE to transmit the one or more sidelink communications in association with the configuration information indicating that the second resource pool is a common resource pool or a cell-specific resource pool.

6. The UE of claim 1, wherein the processing system is further configured to cause the UE to:
transmit, to another UE, an indication that the second resource pool is to be used by the UE, and wherein transmitting the one or more sidelink communications using the resources of the second resource pool is associated with transmitting the indication that the second resource pool is to be used by the UE.

7. The UE of claim 6, wherein the processing system, to transmit the indication that the second resource pool is to be used by the UE, is configured to cause the UE to transmit the indication using resources associated with the first resource pool.

8. The UE of claim 7, wherein the configuration information indicates an exceptional resource pool associated with sidelink communications for the shared frequency band, and wherein the indication that the second resource pool is to be used by the UE is communicated using resources associated with the exceptional resource pool.

9. The UE of claim 1, wherein the configuration information indicates an exceptional resource pool associated with sidelink communications for the shared frequency band, and wherein the second resource pool is the exceptional resource pool.

10. The UE of claim 9, wherein the processing system, to transmit the one or more sidelink communications, is configured to cause the UE to transmit the one or more sidelink communications in association with a frequency domain overlap between first frequency domain resources of the first resource pool and second frequency domain resources of the exceptional resource pool satisfying an overlap threshold.

11. A network node for wireless communication, comprising:
a processing system that includes one or more processors and one or more memories coupled with the one or more processors, the processing system configured to cause the network node to:
transmit configuration information, associated with a user equipment (UE), indicating multiple resource pools associated with sidelink communications for a shared frequency band, the configuration information associated with one or more alternative resource pools for resource pool based persistent listen-before-talk (LBT) failures associated with the multiple resource pools.

12. The network node of claim 11, wherein the configuration information indicates a prioritization between having no frequency domain overlap between a resource pool associated with a persistent LBT failure and an alternative resource pool, of the one or more alternative resource pools, and a comparison of a first configuration of the resource pool and a second configuration of the alternative resource pool.

13. The network node of claim 11, wherein the configuration information indicates an exceptional resource pool associated with sidelink communications for the shared frequency band, and
wherein the one or more alternative resource pools include the exceptional resource pool.

14. The network node of claim 13, wherein the configuration information indicates that the exceptional resource pool is used for sidelink transmissions associated with one or more conditions being met.

15. The network node of claim 14, wherein the one or more conditions include an amount of time that the exceptional resource pool has been used satisfying a time threshold.

16. A method of wireless communication by a user equipment (UE), comprising:
receiving configuration information indicating multiple resource pools associated with sidelink communications for a shared frequency band; and
transmitting, via the shared frequency band, one or more sidelink communications that are associated with a first resource pool, of the multiple resource pools, using resources of a second resource pool of the multiple resource pools, the use of the resources of the second resource pool being associated with the first resource pool having a persistent listen-before-talk (LBT) failure, the persistent LBT failure being associated with one or more LBT failures via resources associated with the first resource pool.

17. The method of claim 16, further comprising:
transmitting, to another UE, an indication that the second resource pool is to be used by the UE, and wherein transmitting the one or more sidelink communications using the resources of the second resource pool is associated with transmitting the indication that the second resource pool is to be used by the UE.

18. (canceled)

19. (canceled)

20. The method of claim 16, wherein the configuration information indicates an exceptional resource pool associated with sidelink communications for the shared frequency band, and wherein the second resource pool is the exceptional resource pool.

21. (canceled)

22. The method of claim 16, wherein the configuration information indicates that the second resource pool is available to be used as an alternative resource pool for resource pools, of the multiple resource pools, that experience persistent LBT failures, and
wherein transmitting the one or more sidelink communications using the resources of the second resource pool is associated with the configuration information indicating that the second resource pool is available to be used as the alternative resource pool.

23-30. (canceled)
